(19) United States
(12) Patent Application Publication
(10) Pub. No.: US 2016/0156907 A1
(43) Pub. Date: Jun. 2, 2016

(54) Method for Determining Block Partitioning Manner and Optimal Prediction Mode in Video Coding and Related Apparatus

(71) Applicant: Huawei Technologies Co., Ltd., Shenzhen (CN)

(72) Inventors: Fan Liang, Shenzhen (CN); Huanbang Chen, Shenzhen (CN); Jianhua Zheng, Beijing (CN)

(21) Appl. No.: 15/016,544

(22) Filed: Feb. 5, 2016

Related U.S. Application Data
(63) Continuation of application No. PCT/CN2014/082032, filed on Jul. 11, 2014.

(30) Foreign Application Priority Data
Jan. 21, 2014 (CN) 201410028766.0

(51) Int. Cl. H04N 19/119; H04N 19/103; H04N 19/176; H04N 19/66; H04N 19/96; H04N 19/70; H04N 19/147

(52) U.S. Cl. CPC H04N 19/119; H04N 19/70; H04N 19/103; H04N 19/147; H04N 19/66; H04N 19/96; H04N 19/176

(57) ABSTRACT

A method for determining a block partitioning manner and an optimal prediction mode in video coding and a related apparatus. The method for determining a block partitioning manner in video coding that is provided in embodiments of the present disclosure may include: determining an allowable block partitioning depth set of a current block; and determining, according to the allowable block partitioning depth set, whether sub-block partitioning is performed on the current block at a current partitioning depth. Solutions in the embodiments of the present disclosure help to reduce calculation complexity in determining a block partitioning manner of a current block in a video coding process.

### CROSS-REFERENCE TO RELATED APPLICATIONS

This application is a continuation of International Application No. PCT/CN2014/082032, filed on Jul. 11, 2014, which claims priority to Chinese Patent Application No. 201410028766.0, filed on Jan. 21, 2014, both of which are hereby incorporated by reference in their entireties.

### TECHNICAL FIELD

The present disclosure relates to the field of picture processing technologies, and in particular, to a method for determining a block partitioning manner and an optimal prediction mode in video coding and a related apparatus.

### BACKGROUND

With the development of an video capture technology and an increasing high definition digital video requirement, a video data amount becomes increasingly large, and limited transmission bandwidth and diverse video applications place an increasingly high demand on efficiency of video coding. A task to formulate the high efficiency video coding (HEVC) standard is started as required.

A basic principle of video coding and compression is to minimize redundancy using a correlation between a spatial domain, a time domain, and a code word. A currently popular practice is to use a block-based hybrid video coding framework to implement video coding and compression by performing steps such as prediction (including intra-frame prediction and inter-frame prediction), transformation, quantization, and entropy coding. This coding framework has shown great vitality, and HEVC still uses this block-based hybrid video coding framework.

In the foregoing coding framework, a video sequence includes a series of pictures, a picture is further divided into slices, and a slice is further divided into blocks. Video coding is performed on a per block basis, and coding processing may be started from a top left corner of a picture and performed line by line from left to right and from top to bottom. In some new video coding standards, a concept of Block is further extended. The H. 264 standard defines a macroblock (MB), and an MB may be further divided into multiple transform blocks. In the HEVC standard, basic concepts such as a coding unit (CU), a prediction unit (PU), and a transform unit (TU) are used for functional division of many types of units, and a brand-new tree structure is used for description. For example, a CU may be divided into smaller CUs according to a quadtree, and a smaller CU may be further divided, thereby forming a quadtree structure. A PU and a TU also have a similar tree structure. In essence, all the CU, the PU, and the TU belong to the concept of block. The CU is similar to a macroblock MB or a code block and is a basic unit for division and coding on a coding picture. A PU may be corresponding to a prediction block and is a basic unit for prediction coding. A CU is further divided into multiple PUs according to a division mode. A TU may be corresponding to a transform block and is a basic unit for transformation on a prediction residual. In the HEVC standard, the CU, the PU, and the TU may be collectively referred to as a coding tree block (CTB).

In the HEVC standard, a picture block is further partitioned generally in a quadtree partitioning manner, for example, when an upper-level CU is divided into sub-coding units (Sub-CUs), a block split_flag is used to indicate whether a current Sub-CU is further partitioned into smaller Sub-CUs. In the prior art, in determining whether a current block continues to be partitioned, performance parameters such as rate-distortion costs of multiple blocks need to be calculated. However, calculating the performance parameters such as the rate-distortion costs of the multiple blocks each time makes a calculation process relatively complex.

### SUMMARY

Embodiments of the present disclosure provide a method for determining a block partitioning manner and an optimal prediction mode in video coding and a related apparatus, which are intended to reduce calculation complexity in determining a block partitioning manner of a current block in a video coding process.

A first aspect of the embodiments of the present disclosure provides a method for determining a block partitioning manner in video coding, which may include determining an allowable block partitioning depth set of a current block, and determining, according to the allowable block partitioning depth set, whether sub-block partitioning is performed on the current block at a current partitioning depth.

With reference to the first aspect, in a first possible implementation manner of the first aspect, if the current partitioning depth of the current block does not belong to the allowable block partitioning depth set, an optimal prediction mode of the current block at the current partitioning depth is not calculated.

With reference to the first aspect, in a second possible implementation manner of the first aspect, the determining, according to the allowable block partitioning depth set, whether sub-block partitioning is performed on the current block at a current partitioning depth includes, if the current partitioning depth of the current block is greater than a maximum block partitioning depth in the allowable block partitioning depth set, determining that sub-block partitioning is not performed on the current block.

With reference to the first aspect, in a third possible implementation manner of the first aspect, the determining, according to the allowable block partitioning depth set, whether sub-block partitioning is performed on the current block at a current partitioning depth includes, if the current partitioning depth of the current block belongs to the allowable block partitioning depth set, or the current partitioning depth of the current block is less than a minimum block partitioning depth in the allowable block partitioning depth set, calculating a rate-distortion cost obtained after sub-block partitioning is performed on the current block, and if a rate-distortion cost of the current block is less than or equal to the rate-distortion cost obtained after sub-block partitioning is performed on the current block, determining that sub-block partitioning is not performed on the current block, or if a rate-distortion cost of the current block is greater than the rate-distortion cost obtained after sub-block partitioning is performed on the current block, determining that sub-block partitioning is performed on the current block.

With reference to the third possible implementation manner of the first aspect, in a fourth possible implementation manner of the first aspect, if the current partitioning depth of the current block belongs to the allowable block partitioning depth set, the rate-distortion cost of the current block is a rate-distortion cost of the current block in an optimal prediction mode.

With reference to the fourth possible implementation manner of the first aspect, in a fifth possible implementation manner of the first aspect, the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

With reference to the third possible implementation manner of the first aspect, the fourth possible implementation manner of the first aspect, or the fifth possible implementation manner of the first aspect, in a sixth possible implementation manner of the first aspect, the calculating a rate-distortion cost obtained after sub-block partitioning is performed on the current block includes obtaining, based on rate-distortion costs of sub-blocks into which the current block is partitioned, the rate-distortion cost obtained after sub-block partitioning is performed on the current block.

With reference to the sixth possible implementation manner of the first aspect, in a seventh possible implementation manner of the first aspect, the obtaining, based on rate-distortion costs of sub-blocks into which the current block is partitioned, the rate-distortion cost obtained after sub-block partitioning is performed on the current block includes using a weighted combination of rate-distortion costs of all sub-blocks into which the current block is partitioned as the rate-distortion cost obtained after sub-block partitioning is performed on the current block; or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block, or obtaining, according to any rate-distortion cost of rate-distortion costs of all sub-blocks into which the current block is partitioned, the rate-distortion cost obtained after sub-block partitioning is performed on the current block, or obtaining, according to an average value of rate-distortion costs of all sub-blocks into which the current block is partitioned, the rate-distortion cost obtained after sub-block partitioning is performed on the current block.

With reference to the first aspect, the first possible implementation manner of the first aspect, the second possible implementation manner of the first aspect, the third possible implementation manner of the first aspect, the fourth possible implementation manner of the first aspect, the fifth possible implementation manner of the first aspect, the sixth possible implementation manner of the first aspect, or the seventh possible implementation manner of the first aspect, in an eighth possible implementation manner of the first aspect, the allowable block partitioning depth set is a frame-level allowable block partitioning depth set, a block-level allowable block partitioning depth set, or a union set of a frame-level allowable block partitioning depth set and a block-level allowable block partitioning depth set.

With reference to the eighth possible implementation manner of the first aspect, in a ninth possible implementation manner of the first aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the ninth possible implementation manner of the first aspect, in a tenth possible implementation manner of the first aspect, the statistical period is a length of one group of pictures (GOP) or an interval between two adjacent intra-frames.

With reference to the eighth possible implementation manner of the first aspect, the ninth possible implementation manner of the first aspect, or the tenth possible implementation manner of the first aspect, in an eleventh possible implementation manner of the first aspect, the block-level allowable block partitioning depth set includes K block partitioning depths used by a prediction block of the current block, where K is a positive integer.

With reference to the third possible implementation manner of the first aspect, the fourth possible implementation manner of the first aspect, the fifth possible implementation manner of the first aspect, the sixth possible implementation manner of the first aspect, the seventh possible implementation manner of the first aspect, the eighth possible implementation manner of the first aspect, the ninth possible implementation manner of the first aspect, the tenth possible implementation manner of the first aspect, or the eleventh possible implementation manner of the first aspect, in a twelfth possible implementation manner of the first aspect, if the current partitioning depth of the current block is less than the minimum block partitioning depth in the allowable block partitioning depth set, the rate-distortion cost of the current block is a rate-distortion cost of the current block in a current prediction mode.

A second aspect of the embodiments of the present disclosure provides a method for determining an optimal prediction mode of a current block in video coding, which may include determining an allowable block partitioning depth set of a current block, and determining an optimal prediction mode of the current block according to the allowable block partitioning depth set.

With reference to the second aspect, in a first possible implementation manner of the second aspect, if a current partitioning depth of the current block does not belong to the allowable block partitioning depth set, the optimal prediction mode of the current block at the current partitioning depth is not calculated.

With reference to the second aspect, in a second possible implementation manner of the second aspect, the determining an optimal prediction mode of the current block according to the allowable block partitioning depth set includes, if a current partitioning depth of the current block does not belong to the allowable block partitioning depth set, using a current prediction mode of the current block as the optimal prediction mode of the current block.

With reference to the second aspect, in a third possible implementation manner of the second aspect, the determining an optimal prediction mode of the current block according to the allowable block partitioning depth set includes, if a current partitioning depth of the current block belongs to the allowable block partitioning depth set, obtaining the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

With reference to the second aspect, the first possible implementation manner of the second aspect, the second possible implementation manner of the second aspect, or the third possible implementation manner of the second aspect, in a fourth possible implementation manner of the second aspect, the optimal prediction mode of the current block is any one of the following prediction modes: a skip mode, a direct mode, a block prediction mode, and a non-block prediction mode.

With reference to the fourth possible implementation manner of the second aspect, in a fifth possible implementation manner of the second aspect, the block prediction mode is a 2N*2N prediction mode or an N*N prediction mode, where N is a positive integer.

With reference to the fourth possible implementation manner of the second aspect, in a sixth possible implementation manner of the second aspect, the non-block prediction mode is a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer.

With reference to the second aspect, the first possible implementation manner of the second aspect, the second possible implementation manner of the second aspect, the third possible implementation manner of the second aspect, the fourth possible implementation manner of the second aspect, the fifth possible implementation manner of the second aspect, or the sixth possible implementation manner of the second aspect, in a seventh possible implementation manner of the second aspect, the allowable block partitioning depth set is a frame-level allowable block partitioning depth set, a block-level allowable block partitioning depth set, or a union set of a frame-level allowable block partitioning depth set and a block-level allowable block partitioning depth set.

With reference to the seventh possible implementation manner of the second aspect, in an eighth possible implementation manner of the second aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the eighth possible implementation manner of the second aspect, in a ninth possible implementation manner of the second aspect, the statistical period is a length of one GOP or an interval between two adjacent intra-frames.

With reference to the seventh possible implementation manner of the second aspect, the eighth possible implementation manner of the second aspect, or the ninth possible implementation manner of the second aspect, in a tenth possible implementation manner of the second aspect, the block-level allowable block partitioning depth set includes K block partitioning depths used by a prediction block of the current block, where K is a positive integer.

A third aspect of the embodiments of the present disclosure provides a video coder, which may include a set determining unit configured to determine an allowable block partitioning depth set of a current block; and a partitioning determining unit configured to determine, according to the allowable block partitioning depth set, whether sub-block partitioning is performed on the current block at a current partitioning depth.

With reference to the third aspect, in a first possible implementation manner of the third aspect, if the current partitioning depth of the current block does not belong to the allowable block partitioning depth set, the partitioning determining unit does not calculate an optimal prediction mode of the current block at the current partitioning depth.

With reference to the third aspect, in a second possible implementation manner of the third aspect, the partitioning determining unit is further configured to, if the current partitioning depth of the current block is greater than a maximum block partitioning depth in the allowable block partitioning depth set, determine that sub-block partitioning is not performed on the current block.

With reference to the third aspect, in a third possible implementation manner of the third aspect, the partitioning determining unit is further configured to, if the current partitioning depth of the current block belongs to the allowable block partitioning depth set, or the current partitioning depth of the current block is less than a minimum block partitioning depth in the allowable block partitioning depth set, calculate a rate-distortion cost obtained after sub-block partitioning is performed on the current block, and if a rate-distortion cost of the current block is less than or equal to the rate-distortion cost obtained after sub-block partitioning is performed on the current block, determine that sub-block partitioning is not performed on the current block, or if a rate-distortion cost of the current block is greater than the rate-distortion cost obtained after sub-block partitioning is performed on the current block, determine that sub-block partitioning is performed on the current block.

With reference to the third possible implementation manner of the third aspect, in a fourth possible implementation manner of the third aspect, if the current partitioning depth of the current block belongs to the allowable block partitioning depth set, the rate-distortion cost of the current block is a rate-distortion cost of the current block in an optimal prediction mode.

With reference to the fourth possible implementation manner of the third aspect, in a fifth possible implementation manner of the third aspect, the optimal prediction mode of the current block is a prediction mode with a minimum rate-distortion cost in all optional prediction modes of the current block at the current partitioning depth, or a prediction mode with a minimum rate-distortion cost in multiple optional prediction modes of the current block at the current partitioning depth.

With reference to the third possible implementation manner of the third aspect, the fourth possible implementation manner of the third aspect, or the fifth possible implementation manner of the third aspect, in a sixth possible implementation manner of the third aspect, with respect to the calculating a rate-distortion cost obtained after sub-block partitioning is performed on the current block, the partitioning determining unit is further configured to obtain, based on rate-distortion costs of sub-blocks into which the current block is partitioned, the rate-distortion cost obtained after sub-block partitioning is performed on the current block.

With reference to the sixth possible implementation manner of third aspect, in a seventh possible implementation manner of the third aspect, with respect to the obtaining, based on rate-distortion costs of sub-blocks into which the current block is partitioned, the rate-distortion cost obtained after sub-block partitioning is performed on the current block, the partitioning determining unit is further configured to use a weighted combination of rate-distortion costs of all sub-blocks into which the current block is partitioned as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block, or obtain, according to a maximum rate-distortion cost or a minimum rate-distortion cost of rate-distortion costs of all sub-blocks into which the current block is partitioned, the rate-distortion cost obtained after sub-block partitioning is performed on the current block, or obtain, according to any rate-distortion cost of rate-distortion costs of all sub-blocks into which the current block is partitioned, the rate-distortion cost obtained after sub-block partitioning is performed on the current block, or obtain, according to an average value of rate-distortion costs of all sub-blocks into which the current block is partitioned, the rate-distortion cost obtained after sub-block partitioning is performed on the current block.

With reference to the third aspect, the first possible implementation manner of the third aspect, the second possible implementation manner of the third aspect, the third possible implementation manner of the third aspect, the fourth possible implementation manner of the third aspect, the fifth possible implementation manner of the third aspect, the sixth possible implementation manner of the third aspect, or the seventh possible implementation manner of the third aspect, in an eighth possible implementation manner of the third aspect, the allowable block partitioning depth set is a frame-level allowable block partitioning depth set, a block-level allowable block partitioning depth set, or a union set of a frame-level allowable block partitioning depth set and a block-level allowable block partitioning depth set.

With reference to the eighth possible implementation manner of the third aspect, in a ninth possible implementation manner of the third aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the ninth possible implementation manner of the third aspect, in a tenth possible implementation manner of the third aspect, the statistical period is a length of one GOP or an interval between two adjacent intra-frames.

With reference to the eighth possible implementation manner of the third aspect, the ninth possible implementation manner of the third aspect, or the tenth possible implementation manner of the third aspect, in an eleventh possible implementation manner of the third aspect, the block-level allowable block partitioning depth set includes K block partitioning depths used by a prediction block of the current block, where K is a positive integer.

With reference to the third possible implementation manner of the third aspect, the fourth possible implementation manner of the third aspect, the fifth possible implementation manner of the third aspect, the sixth possible implementation manner of the third aspect, the seventh possible implementation manner of the third aspect, the eighth possible implementation manner of the third aspect, the ninth possible implementation manner of the third aspect, the tenth possible implementation manner of the third aspect, or the eleventh possible implementation manner of the third aspect, in a twelfth possible implementation manner of the third aspect, if the current partitioning depth of the current block is less than the minimum block partitioning depth in the allowable block partitioning depth set, the rate-distortion cost of the current block is a rate-distortion cost of the current block in a current prediction mode.

A fourth aspect of the embodiments of the present disclosure provides a video coder, which may include a set determining unit configured to determine an allowable block partitioning depth set of a current block; and a prediction mode determining unit configured to determine an optimal prediction mode of the current block according to the allowable block partitioning depth set.

With reference to the fourth aspect, in a first possible implementation manner of the fourth aspect, if a current partitioning depth of the current block does not belong to the allowable block partitioning depth set, the prediction mode determining unit does not calculate an optimal prediction mode of the current block at the current partitioning depth.

With reference to the fourth aspect, in a second possible implementation manner of the fourth aspect, the prediction mode determining unit is further configured to, if a current partitioning depth of the current block does not belong to the allowable block partitioning depth set, use a current prediction mode of the current block as the optimal prediction mode of the current block.

With reference to the fourth aspect, in a third possible implementation manner of the fourth aspect, the prediction mode determining unit is further configured to, if a current partitioning depth of the current block belongs to the allowable block partitioning depth set, obtain the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

With reference to the fourth aspect, the first possible implementation manner of the fourth aspect, the second possible implementation manner of the fourth aspect, or the third possible implementation manner of the fourth aspect, in a fourth possible implementation manner of the fourth aspect, the optimal prediction mode of the current block is any one of the following prediction modes: a skip mode, a direct mode, a block prediction mode, and a non-block prediction mode.

With reference to the fourth possible implementation manner of the fourth aspect, in a fifth possible implementation manner of the fourth aspect, the block prediction mode is a 2N*2N prediction mode or an N*N prediction mode, where N is a positive integer.

With reference to the fourth possible implementation manner of the fourth aspect, in a sixth possible implementation manner of the fourth aspect, the non-block prediction mode is a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer.

With reference to the fourth aspect, the first possible implementation manner of the fourth aspect, the second possible implementation manner of the fourth aspect, the third possible implementation manner of the fourth aspect, the fourth possible implementation manner of the fourth aspect, or the sixth possible implementation manner of the fourth aspect, in a seventh possible implementation manner of the fourth aspect, the allowable block partitioning depth set is: a frame-level allowable block partitioning depth set, a block-level allowable block partitioning depth set, or a union set of a frame-level allowable block partitioning depth set and a block-level allowable block partitioning depth set.

With reference to the sixth possible implementation manner of the fourth aspect, in a seventh possible implementation manner of the fourth aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the eighth possible implementation manner of the fourth aspect, in ninth possible implementation manner of the fourth aspect, the statistical period is a length of one GOP or an interval between two adjacent intra-frames.

With reference to the seventh possible implementation manner of the fourth aspect, the eighth possible implementation manner of the fourth aspect, or the ninth possible implementation manner of the fourth aspect, in a tenth possible implementation manner of the fourth aspect, the block-level allowable block partitioning depth set includes K block partitioning depths used by a prediction block of the current block, where K is a positive integer.

According to a fifth aspect, a video coder is provided, including a memory and a processor that is connected to the memory, where the processor is configured to determine an allowable block partitioning depth set of a current block; and determine, according to the allowable block partitioning depth set, whether sub-block partitioning is performed on the current block at a current partitioning depth.

With reference to the fifth aspect, in a first possible implementation manner of the fifth aspect, if the current partitioning depth of the current block does not belong to the allowable block partitioning depth set, the processor does not calculate an optimal prediction mode of the current block at the current partitioning depth.

With reference to the fifth aspect, in a second possible implementation manner of the fifth aspect, the processor is configured to, if the current partitioning depth of the current block is greater than a maximum block partitioning depth in the allowable block partitioning depth set, determine that sub-block partitioning is not performed on the current block.

With reference to the fifth aspect, in a third possible implementation manner of the fifth aspect, the processor is configured to, if the current partitioning depth of the current block belongs to the allowable block partitioning depth set, or the current partitioning depth of the current block is less than a minimum block partitioning depth in the allowable block partitioning depth set, calculate a rate-distortion cost obtained after sub-block partitioning is performed on the current block, and if a rate-distortion cost of the current block is less than or equal to the rate-distortion cost obtained after sub-block partitioning is performed on the current block, determine that sub-block partitioning is not performed on the current block, or if a rate-distortion cost of the current block is greater than the rate-distortion cost obtained after sub-block partitioning is performed on the current block, determine that sub-block partitioning is performed on the current block.

With reference to the third possible implementation manner of the fifth aspect, in a fourth possible implementation manner of the fifth aspect, if the current partitioning depth of the current block belongs to the allowable block partitioning depth set, the rate-distortion cost of the current block is a rate-distortion cost of the current block in an optimal prediction mode.

With reference to the third possible implementation manner of the fifth aspect or the fourth possible implementation manner of the fifth aspect, in a fifth possible implementation manner of the fifth aspect, if the current partitioning depth of the current block is less than the minimum block partitioning depth in the allowable block partitioning depth set, the rate-distortion cost of the current block is a rate-distortion cost of the current block in a current prediction mode.

With reference to the fourth possible implementation manner of the fifth aspect or the fifth possible implementation manner of the fifth aspect, in a sixth possible implementation manner of the fifth aspect, the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

With reference to any one of the third to the sixth possible implementation manners of the fifth aspect, in a seventh possible implementation manner of the fifth aspect, the processor is configured to obtain, based on rate-distortion costs of sub-blocks into which the current block is partitioned, the rate-distortion cost obtained after sub-block partitioning is performed on the current block.

With reference to the seventh possible implementation manner of the fifth aspect, in an eighth possible implementation manner of the fifth aspect, the processor is configured to use a weighted combination of rate-distortion costs of all sub-blocks into which the current block is partitioned as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block, or obtain, according to a maximum rate-distortion cost or a minimum rate-distortion cost of rate-distortion costs of all sub-blocks into which the current block is partitioned, the rate-distortion cost obtained after sub-block partitioning is performed on the current block, or obtain, according to any rate-distortion cost of rate-distortion costs of all sub-blocks into which the current block is partitioned, the rate-distortion cost obtained after sub-block partitioning is performed on the current block, or obtain, according to an average value of rate-distortion costs of all sub-blocks into which the current block is partitioned, the rate-distortion cost obtained after sub-block partitioning is performed on the current block.

With reference to the fifth aspect or any one of the first to the eighth possible implementation manners of the fifth aspect, in a ninth possible implementation manner of the fifth aspect, the allowable block partitioning depth set is a frame-level allowable block partitioning depth set, a block-level allowable block partitioning depth set, or a union set of a frame-level allowable block partitioning depth set and a block-level allowable block partitioning depth set.

With reference to the ninth possible implementation manner of the fifth aspect, in a tenth possible implementation manner of the fifth aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the tenth possible implementation manner of the fifth aspect, in an eleventh possible implementation manner of the fifth aspect, the statistical period is a length of one GOP or an interval between two adjacent intra-frames.

With reference to any one of the ninth to the eleventh possible implementation manners of the fifth aspect, in a twelfth possible implementation manner of the fifth aspect, the block-level allowable block partitioning depth set includes K block partitioning depths used by a prediction block of the current block, where K is a positive integer.

According to a sixth aspect, a video coder is provided, including: a memory and a processor that is connected to the memory, where the processor is configured to: determine an allowable block partitioning depth set of a current block, and determine an optimal prediction mode of the current block according to the allowable block partitioning depth set.

With reference to the sixth aspect, in a first possible implementation manner of the sixth aspect, if a current partitioning depth of the current block does not belong to the allowable block partitioning depth set, the processor does not calculate an optimal prediction mode of the current block at the current partitioning depth.

With reference to the sixth aspect, in a second possible implementation manner of the sixth aspect, the processor is configured to, if a current partitioning depth of the current block does not belong to the allowable block partitioning depth set, use a current prediction mode of the current block as the optimal prediction mode of the current block.

With reference to the sixth aspect, in a third possible implementation manner of the sixth aspect, the processor is configured to, if a current partitioning depth of the current block belongs to the allowable block partitioning depth set, obtain the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

With reference to the sixth aspect, the first possible implementation manner of the sixth aspect, the second possible implementation manner of the sixth aspect, or the third possible implementation manner of the sixth aspect, in a fourth possible implementation manner of the sixth aspect, the optimal prediction mode of the current block is any one of the following prediction modes: a skip mode, a direct mode, a block prediction mode, and a non-block prediction mode.

With reference to the fourth possible implementation manner of the sixth aspect, in a fifth possible implementation manner of the sixth aspect, the block prediction mode is a 2N*2N prediction mode or an N*N prediction mode, where N is a positive integer.

With reference to the fourth possible implementation manner of the sixth aspect, in a sixth possible implementation manner of the sixth aspect, the non-block prediction mode is a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer.

With reference to the sixth aspect or any one of the first to the sixth possible implementation manners of the sixth aspect, in a seventh possible implementation manner of the sixth aspect, the allowable block partitioning depth set is a frame-level allowable block partitioning depth set, a block-level allowable block partitioning depth set, or a union set of a frame-level allowable block partitioning depth set and a block-level allowable block partitioning depth set.

With reference to the seventh possible implementation manner of the sixth aspect, in an eighth possible implementation manner of the sixth aspect, the frame-level allowable block partitioning depth set includes M block partitioning depths that are used most frequently within a current statistical period or until a current moment in a coded video frame that is of a same type as a video frame to which the current block belongs, where M is a positive integer.

With reference to the eighth possible implementation manner of the sixth aspect, in a ninth possible implementation manner of the sixth aspect, the statistical period is a length of one GOP or an interval between two adjacent intra-frames.

With reference to any one of the fifth to the eighth possible implementation manner of the sixth aspect, in a ninth possible implementation manner of the sixth aspect, the block-level allowable block partitioning depth set includes K block partitioning depths used by a prediction block of the current block, where K is a positive integer.

According to a seventh aspect, a computer storage medium is provided, where the computer storage medium may store a program, and when executed, the program includes all or a part of steps of any method for determining a block partitioning manner in video coding that is provided in the embodiments of the present disclosure.

According to an eighth aspect, a computer storage medium is provided, where the computer storage medium may store a program, and when executed, the program includes all or a part of steps of any method for determining an optimal prediction mode of a current block in video coding that is provided in the embodiments of the present disclosure.

It can be learned that in some solution of the embodiments of the present disclosure, an encoding side may first determine an allowable block partitioning depth set of a current block in a video coding process, and then determine, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and persons of ordinary skill in the art may still derive other drawings from these accompanying drawings without creative efforts.

FIG. 1A is a schematic flowchart of a method for determining a block partitioning manner in video coding according to an embodiment of the present disclosure;

FIG. 1B is a schematic diagram of a position relationship between a current block and N related blocks according to an embodiment of the present disclosure;

FIG. 2 is a schematic flowchart of a method for determining an optimal prediction mode of a current block in video coding according to an embodiment of the present disclosure;

FIG. 3 is a schematic flowchart of another method for determining a block partitioning manner in video coding according to an embodiment of the present disclosure;

FIG. 4 is a schematic flowchart of another method for determining a block partitioning manner in video coding according to an embodiment of the present disclosure;

FIG. 5 is a schematic flowchart of another method for determining a block partitioning manner in video coding according to an embodiment of the present disclosure;

FIG. 6 is a schematic flowchart of another method for determining a block partitioning manner in video coding according to an embodiment of the present disclosure;

FIG. 7 is a schematic flowchart of another method for determining a block partitioning manner in video coding according to an embodiment of the present disclosure;

FIG. 8 is a schematic flowchart of another method for determining a block partitioning manner in video coding according to an embodiment of the present disclosure;

FIG. 9A is a schematic flowchart of another method for determining a block partitioning manner in video coding according to an embodiment of the present disclosure;

FIG. 9B and FIG. 9C are schematic diagrams of two prediction block division structures of a current block according to an example in an embodiment of the present disclosure;

FIG. 10 is a schematic flowchart of another method for determining an optimal prediction mode of a current block in video coding according to an embodiment of the present disclosure;

FIG. 11 is a schematic diagram of a video coder according to an embodiment of the present disclosure;

FIG. 12 is a schematic diagram of another video coding device according to an embodiment of the present disclosure;

FIG. 13 is a schematic diagram of another video coder according to an embodiment of the present disclosure;

FIG. 14 is a schematic diagram of another video coder according to an embodiment of the present disclosure;

FIG. 15 is a schematic diagram of another video coding device according to an embodiment of the present disclosure; and

FIG. 16 is a schematic diagram of another video coder according to an embodiment of the present disclosure.

### DESCRIPTION OF EMBODIMENTS

Embodiments of the present disclosure provide a method for determining a block partitioning manner and an optimal prediction mode in video coding and a related apparatus, which are intended to reduce calculation complexity in determining a block partitioning manner of a current block in a video coding process.

To make persons skilled in the art understand the solutions in the present disclosure better, the following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by persons of ordinary skill in the art based on the embodiments of the present disclosure without creative efforts shall fall within the protection scope of the present disclosure.

The following separately describes the technical solutions in detail.

In the specification, claims, and accompanying drawings of the present disclosure, the terms “first”, “second”, “third”, “fourth”, and so on (if existent) are intended to distinguish between similar objects but do not necessarily indicate a specific order or sequence. It should be understood that the data termed in such a way are interchangeable in proper circumstances so that the embodiments of the present disclosure described herein can be implemented in orders except the order illustrated or described herein. In addition, the terms “include”, “contain” and any other variants mean to cover the non-exclusive inclusion, for example, a process, method, system, product, or device that includes a list of steps or units is not necessarily limited to those units, but may include other units not expressly listed or inherent to such a process, method, system, product, or device.

In an embodiment of a method for determining a block partitioning manner in video coding of the present disclosure, the method for determining a block partitioning manner in video coding may include: determining an allowable block partitioning depth set of a current block, and determining, according to the allowable block partitioning depth set, whether sub-block partitioning is performed on the current block at a current partitioning depth.

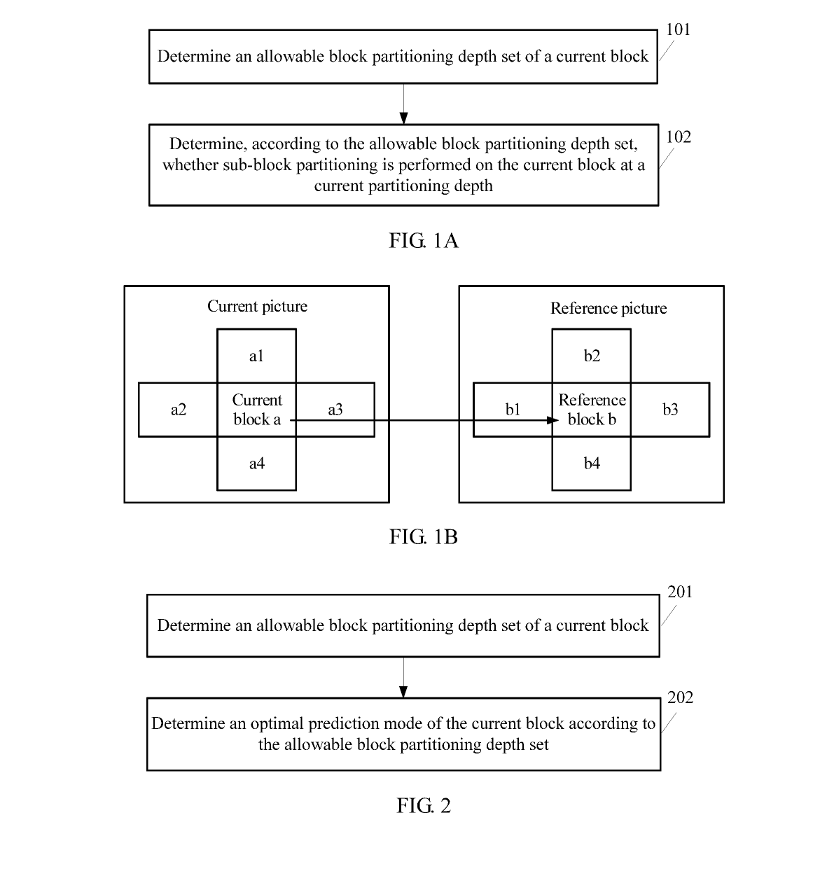

Referring to FIG. 1A, FIG. 1A is a schematic flowchart of a method for determining a block partitioning manner in video coding according to an embodiment of the present disclosure. As shown in FIG. 1A, the method for determining a block partitioning manner in video coding according to this embodiment of the present disclosure may include the following content:

Step 101: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer), or the P related blocks may include the reference block of the current block (in this scenario, P is equal to 1), or the P related blocks may include at least one adjacent block in four adjacent blocks of the reference block of the current block (in this scenario, P is a positive integer), or the P related blocks may include the reference block of the current block and at least one adjacent block in four adjacent blocks of the current block (in this scenario, P is a positive integer greater than 1), or the P related blocks may include the reference block of the current block and at least one adjacent block in four adjacent blocks of the reference block (in this scenario, P is a positive integer greater than 1), or the P related blocks may include at least one adjacent block in four adjacent blocks of the current block and at least one adjacent block in four adjacent blocks of the reference block of the current block (in this scenario, P is a positive integer greater than 1), or the P related blocks may include: the at least one adjacent block of the current block, the reference block of the current block, and the at least one adjacent block of the reference block (in this scenario, P is a positive integer greater than 2).

For example, as shown in FIG. 1B, P related blocks of a current block a may be at least one of the following picture blocks: a picture block a1, a picture block a2, a picture block a3, a picture block a4, a picture block b, a picture block b1, a picture block b2, a picture block b3, and a picture block b4. The picture block a1, the picture block a2, the picture block a3, and the picture block a4 are adjacent blocks of the current block a. The picture block b is a reference block of the current block a, and the picture block b1, the picture block b2, the picture block b3, and the picture block b4 are adjacent blocks of the picture block b.

Step 102: Determine, according to the allowable block partitioning depth set, whether sub-block partitioning is performed on the current block at a current partitioning depth.

In some embodiments of the present disclosure, if the current partitioning depth of the current block does not belong to the allowable block partitioning depth set, an optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, the determining, according to the allowable block partitioning depth set, whether sub-block partitioning is performed on the current block at a current partitioning depth may include, if the current partitioning depth of the current block is greater than a maximum block partitioning depth in the allowable block partitioning depth set, determining that sub-block partitioning is not performed on the current block.

In some embodiments of the present disclosure, the determining, according to the allowable block partitioning depth set, whether sub-block partitioning is performed on the current block at a current partitioning depth may include, if the current partitioning depth of the current block belongs to the allowable block partitioning depth set, or the current partitioning depth of the current block is less than a minimum block partitioning depth in the allowable block partitioning depth set, calculating a rate-distortion cost obtained after sub-block partitioning is performed on the current block, and if a rate-distortion cost of the current block is less than or equal to the rate-distortion cost obtained after sub-block partitioning is performed on the current block, determining that sub-block partitioning is not performed on the current block, or if a rate-distortion cost of the current block is greater than the rate-distortion cost obtained after sub-block partitioning is performed on the current block, determining that sub-block partitioning is performed on the current block.

In some embodiments of the present disclosure, if the current partitioning depth of the current block belongs to the allowable block partitioning depth set, the rate-distortion cost of the current block is a rate-distortion cost of the current block in the optimal prediction mode, if the current partitioning depth of the current block is less than the minimum block partitioning depth in the allowable block partitioning depth set, the rate-distortion cost of the current block is a rate-distortion cost of the current block in a current prediction mode.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block; or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be a positive number (for example, y1 is equal to 0.5, 1, 2, 3, 4, or another value)), or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)), or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

In some embodiments of the present disclosure, the foregoing method may further include determining a block split_flag corresponding to a block partitioning manner (sub-block partitioning is performed or sub-block partitioning is not performed) of the current block.

That the current block is a CU is used as an example. In the HEVC standard, a CU is further partitioned generally in a quadtree partitioning manner, for example, when an upper-level CU is divided into Sub-CUs, a block split_flag is used to indicate whether a current Sub-CU is further partitioned into smaller Sub-CUs. For example, when a value of the split_flag is “1”, it indicates that the current Sub-CU is further partitioned into smaller Sub-CUs, or when the value of the split_flag is “0”, it indicates that the current Sub-CU stops being partitioned. Certainly, the split_flag may also be another value to indicate the block partitioning manner of the current block.

It can be seen that in the solution of this embodiment, an encoding side first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

In an embodiment of a method for determining an optimal prediction mode of a current block in video coding, the method for determining an optimal prediction mode of a current block in video coding may include determining an allowable block partitioning depth set of a current block; and determining an optimal prediction mode of the current block according to the allowable block partitioning depth set.

Referring to FIG. 2, FIG. 2 is a schematic flowchart of a method for determining an optimal prediction mode of a current block in video coding according to an embodiment of the present disclosure. As shown in FIG. 2, the method for determining an optimal prediction mode of a current block in video coding according to this embodiment of the present disclosure may include the following content.

Step 201: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 1 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer); or the P related blocks may include the reference block of the current block (in this scenario, P is a positive integer equal to 1); or the P related blocks may include at least one adjacent block in four adjacent blocks of the reference block of the current block (in this scenario, P is a positive integer); or the P related blocks may include the reference block of the current block and at least one adjacent block in four adjacent blocks of the current block (in this scenario, P is a positive integer greater than 1); or the P related blocks may include the reference block of the current block and at least one adjacent block in four adjacent blocks of the reference block (in this scenario, P is a positive integer greater than 1); or the P related blocks may include at least one adjacent block in four adjacent blocks of the current block and at least one adjacent block in four adjacent blocks of the reference block of the current block (in this scenario, P is a positive integer greater than 1); or the P related blocks may include: the at least one adjacent block of the current block, the reference block of the current block, and the at least one adjacent block of the reference block (in this scenario, P is a positive integer greater than 2).

For example, as shown in FIG. 1B, P related blocks of a current block a may be at least one of the following picture blocks: a picture block a1, a picture block a2, a picture block a3, a picture block a4, a picture block b, a picture block b1, a picture block b2, a picture block b3, and a picture block b4. The picture block a1, the picture block a2, the picture block a3, and the picture block a4 are adjacent blocks of the current block a. The picture block b is a reference block of the current block a, and the picture block b1, the picture block b2, the picture block b3, and the picture block b4 are adjacent blocks of the picture block b.

Step 202: Determine an optimal prediction mode of the current block according to the allowable block partitioning depth set.

In some embodiments of the present disclosure, if a current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, further, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, further, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, the determining an optimal prediction mode of the current block according to the allowable block partitioning depth set may include, if the current partitioning depth of the current block does not belong to the allowable block partitioning depth set, using a current prediction mode of the current block as the optimal prediction mode of the current block.

In some embodiments of the present disclosure, the determining an optimal prediction mode of the current block according to the allowable block partitioning depth set may include, if the current partitioning depth of the current block belongs to the allowable block partitioning depth set, obtaining the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, if the current partitioning depth of the current block belongs to the allowable block partitioning depth set, a rate-distortion cost of the current block may be a rate-distortion cost of the current block in the optimal prediction mode; and/or if the current partitioning depth of the current block is less than a minimum block partitioning depth in the allowable block partitioning depth set, the rate-distortion cost of the current block is a rate-distortion cost of the current block in the current prediction mode.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block; or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)), or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)), or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

In some embodiments of the present disclosure, the foregoing method may further include determining a block split_flag corresponding to a block partitioning manner (sub-block partitioning is performed or sub-block partitioning is not performed) of the current block.

That the current block is a CU is used as an example. In the HEVC standard, a CU is further partitioned generally in a quadtree partitioning manner, for example, when an upper-level CU is divided into Sub-CUs, a block split_flag is used to indicate whether a current Sub-CU is further partitioned into smaller Sub-CUs. For example, when a value of the split_flag is “1”, it indicates that the current Sub-CU is further partitioned into smaller Sub-CUs; or when the value of the split_flag is “0”, it indicates that the current Sub-CU stops being partitioned. Certainly, the split_flag may also be another value to indicate the block partitioning manner of the current block.

It can be seen that in the solution of this embodiment, an encoding side first determines an allowable block partitioning depth set of a current block in a video coding process; and then determines, according to the allowable block partitioning depth set, an optimal prediction mode of the current block. The encoding side can determine the optimal prediction mode of the current block according to the allowable block partitioning depth set of the current block, instead of determining the optimal prediction mode of the current block by calculating performance parameters such as rate-distortion costs of multiple blocks each time, thereby helping to reduce calculation complexity in determining the optimal prediction mode of the current block in the video coding process, and further helps to reduce calculation complexity in determining a block partitioning manner of the current block in the video coding process.

Further, the allowable block partitioning depth set of the current block may be a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

For better understanding and implementing the foregoing solutions of the embodiments of the present disclosure, the following gives examples of some specific application scenarios for description.

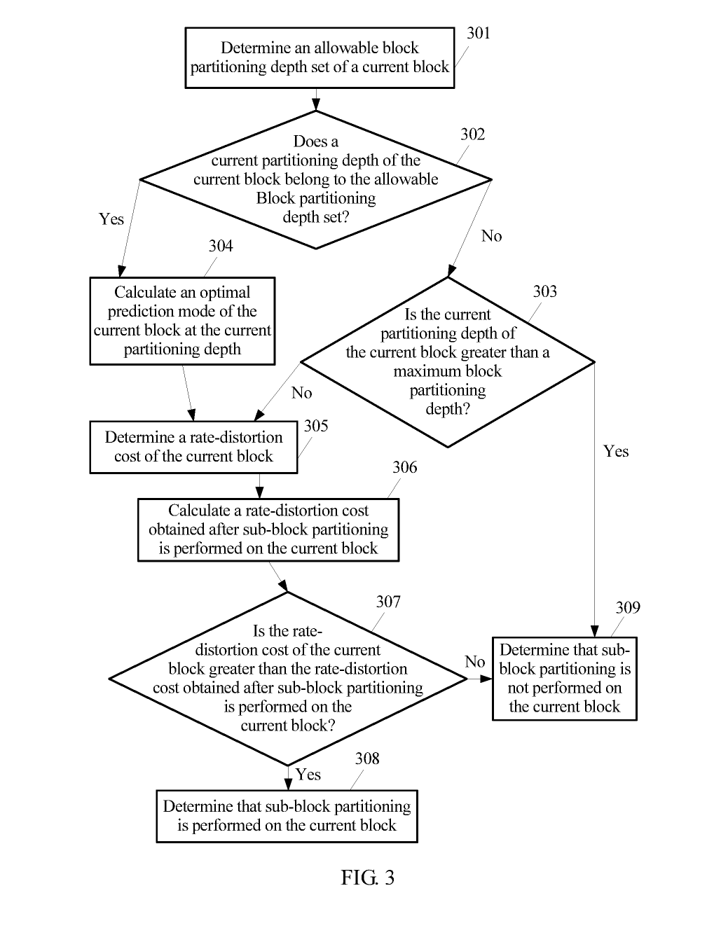

Referring to FIG. 3, FIG. 3 is a schematic flowchart of another method for determining a block partitioning manner in video coding according to an embodiment of the present disclosure. As shown in FIG. 3, another method for determining a block partitioning manner in video coding according to this embodiment of the present disclosure may include the following content.

Step 301: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 1 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

Step 302: Determine whether a current partitioning depth of the current block belongs to the allowable block partitioning depth set.

If the current partitioning depth of the current block belongs to the allowable block partitioning depth set, go to step 304.

If the current partitioning depth of the current block does not belong to the allowable block partitioning depth set, go to step 303.

Step 303: Determine whether the current partitioning depth of the current block is greater than a maximum block partitioning depth in the allowable block partitioning depth set.

If the current partitioning depth of the current block is greater than a maximum block partitioning depth in the allowable block partitioning depth set, go to step 309.

If the current partitioning depth of the current block is not greater than a maximum block partitioning depth in the allowable block partitioning depth set, go to step 305.

Step 304: Calculate an optimal prediction mode of the current block at the current partitioning depth.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to calculate the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 305: Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 306: Calculate a rate-distortion cost obtained after sub-block partitioning is performed on the current block.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)), or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)), or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 307: Determine whether the rate-distortion cost of the current block is greater than the rate-distortion cost obtained after sub-block partitioning is performed on the current block.

If the rate-distortion cost of the current block is greater than the rate-distortion cost obtained after sub-block partitioning is performed on the current block, go to step 308.

If the rate-distortion cost of the current block is not greater than the rate-distortion cost obtained after sub-block partitioning is performed on the current block, go to step 309.

Step 308: Determine that sub-block partitioning is performed on the current block.

Step 309: Determine that sub-block partitioning is not performed on the current block.

It can be seen that in the solution of this embodiment, an encoding side first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

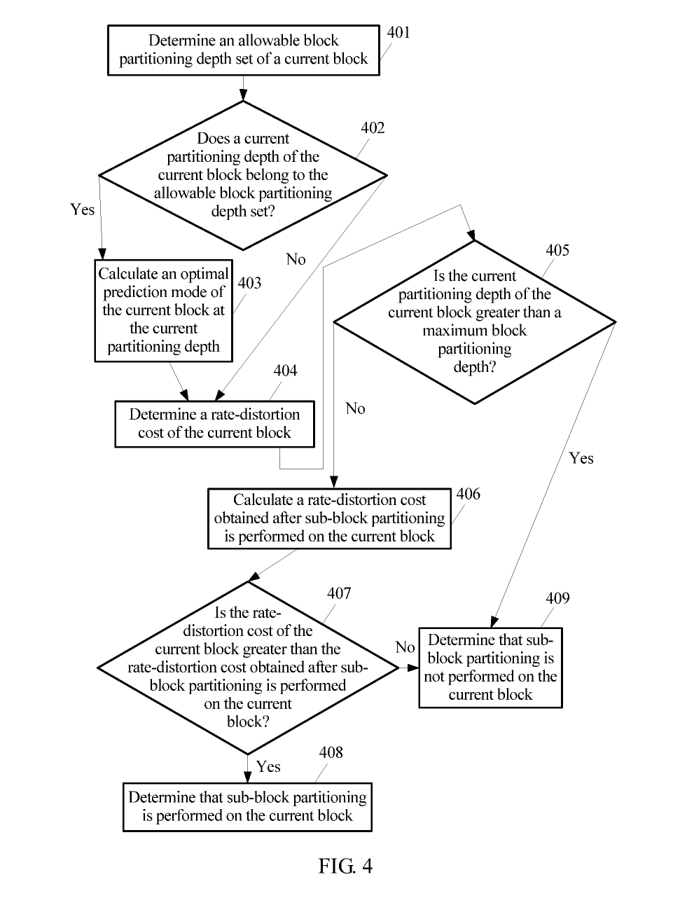

Referring to FIG. 4, FIG. 4 is a schematic flowchart of another method for determining a block partitioning manner in video coding according to an embodiment of the present disclosure. As shown in FIG. 4, another method for determining a block partitioning manner in video coding according to this embodiment of the present disclosure may include the following content.

Step 401: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame; or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

Step 402: Determine whether a current partitioning depth of the current block belongs to the allowable block partitioning depth set.

If the current partitioning depth of the current block belongs to the allowable block partitioning depth set, go to step 403.

If the current partitioning depth of the current block does not belong to the allowable block partitioning depth set, go to step 404.

Step 403: Calculate an optimal prediction mode of the current block at the current partitioning depth, and go to step 404.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 404: Determine a rate-distortion cost of the current block, and go to step 405.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 405: Determine whether the current partitioning depth of the current block is greater than a maximum block partitioning depth in the allowable block partitioning depth set.

If the current partitioning depth of the current block is greater than a maximum block partitioning depth in the allowable block partitioning depth set, go to step 409.

If the current partitioning depth of the current block is not greater than a maximum block partitioning depth in the allowable block partitioning depth set, go to step 406.

Step 406: Calculate a rate-distortion cost obtained after sub-block partitioning is performed on the current block.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes: using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 407: Determine whether the rate-distortion cost of the current block is greater than the rate-distortion cost obtained after sub-block partitioning is performed on the current block.

If the rate-distortion cost of the current block is greater than the rate-distortion cost obtained after sub-block partitioning is performed on the current block, go to step 408.

If the rate-distortion cost of the current block is not greater than the rate-distortion cost obtained after sub-block partitioning is performed on the current block, go to step 409.

Step 408: Determine that sub-block partitioning is performed on the current block.

Step 409: Determine that sub-block partitioning is not performed on the current block.

It can be seen that in the solution of this embodiment, an encoding side first determines an allowable block partitioning depth set of a current block in a video coding process; and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

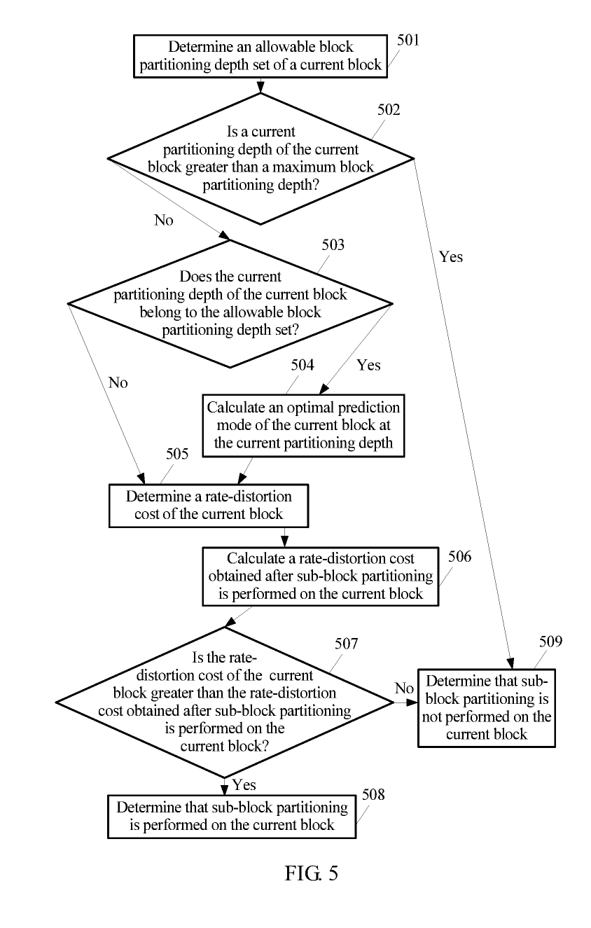

Referring to FIG. 5, FIG. 5 is a schematic flowchart of another method for determining a block partitioning manner in video coding according to an embodiment of the present disclosure. As shown in FIG. 5, another method for determining a block partitioning manner in video coding according to this embodiment of the present disclosure may include the following content.

Step 501: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

Step 502: Determine whether a current partitioning depth of the current block is greater than a maximum block partitioning depth in the allowable block partitioning depth set.

If the current partitioning depth of the current block is greater than a maximum block partitioning depth in the allowable block partitioning depth set, go to step 509.

If the current partitioning depth of the current block is not greater than a maximum block partitioning depth in the allowable block partitioning depth set, go to step 503.

Step 503: Determine whether the current partitioning depth of the current block belongs to the allowable block partitioning depth set.

If the current partitioning depth of the current block belongs to the allowable block partitioning depth set, go to step 504.

If the current partitioning depth of the current block does not belong to the allowable block partitioning depth set, go to step 505.

Step 504: Calculate an optimal prediction mode of the current block at the current partitioning depth, and go to step 505.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 505; Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode; or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 506: Calculate a rate-distortion cost obtained after sub-block partitioning is performed on the current block.

In some embodiments of the present disclosure, the calculating a rate-distortion cost obtained after sub-block partitioning is performed on the current block may include: calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 507: Determine whether the rate-distortion cost of the current block is greater than the rate-distortion cost obtained after sub-block partitioning is performed on the current block.

If the rate-distortion cost of the current block is greater than the rate-distortion cost obtained after sub-block partitioning is performed on the current block, go to step 508.

If the rate-distortion cost of the current block is not greater than the rate-distortion cost obtained after sub-block partitioning is performed on the current block, go to step 509.

Step 508: Determine that sub-block partitioning is performed on the current block.

Step 509: Determine that sub-block partitioning is not performed on the current block.

It can be seen that in the solution of this embodiment, an encoding side first determines an allowable block partitioning depth set of a current block in a video coding process; and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

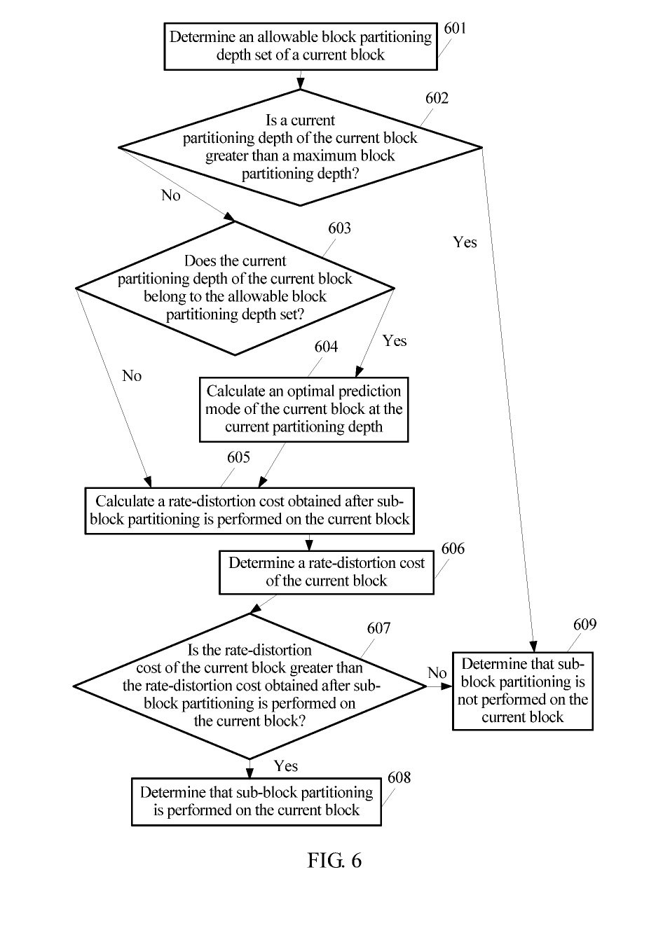

Referring to FIG. 6, FIG. 6 is a schematic flowchart of another method for determining a block partitioning manner in video coding according to an embodiment of the present disclosure. As shown in FIG. 6, another method for determining a block partitioning manner in video coding according to this embodiment of the present disclosure may include the following content.

Step 601: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 6, or M may be equal to 2, 3, 4, 6, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 6, or K may be equal to 1, 2, 3, 4, 6, 6, 7, or another value.

Step 602: Determine whether a current partitioning depth of the current block is greater than a maximum block partitioning depth in the allowable block partitioning depth set.

If the current partitioning depth of the current block is greater than a maximum block partitioning depth in the allowable block partitioning depth set, go to step 609.

If the current partitioning depth of the current block is not greater than a maximum block partitioning depth in the allowable block partitioning depth set, go to step 603.

Step 603: Determine whether the current partitioning depth of the current block belongs to the allowable block partitioning depth set.

If the current partitioning depth of the current block belongs to the allowable block partitioning depth set, go to step 604.

If the current partitioning depth of the current block does not belong to the allowable block partitioning depth set, go to step 605.

Step 604: Calculate an optimal prediction mode of the current block at the current partitioning depth, and go to step 605.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, further, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 605: Calculate a rate-distortion cost obtained after sub-block partitioning is performed on the current block.

In some embodiments of the present disclosure, the calculating a rate-distortion cost obtained after sub-block partitioning is performed on the current block may include: calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes: using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.6, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.6, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.6, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 606: Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 607: Determine whether the rate-distortion cost of the current block is greater than the rate-distortion cost obtained after sub-block partitioning is performed on the current block.

If the rate-distortion cost of the current block is greater than the rate-distortion cost obtained after sub-block partitioning is performed on the current block, go to step 608.

If the rate-distortion cost of the current block is not greater than the rate-distortion cost obtained after sub-block partitioning is performed on the current block, go to step 609.

Step 608: Determine that sub-block partitioning is performed on the current block.

Step 609: Determine that sub-block partitioning is not performed on the current block.

It can be seen that in the solution of this embodiment, an encoding side first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

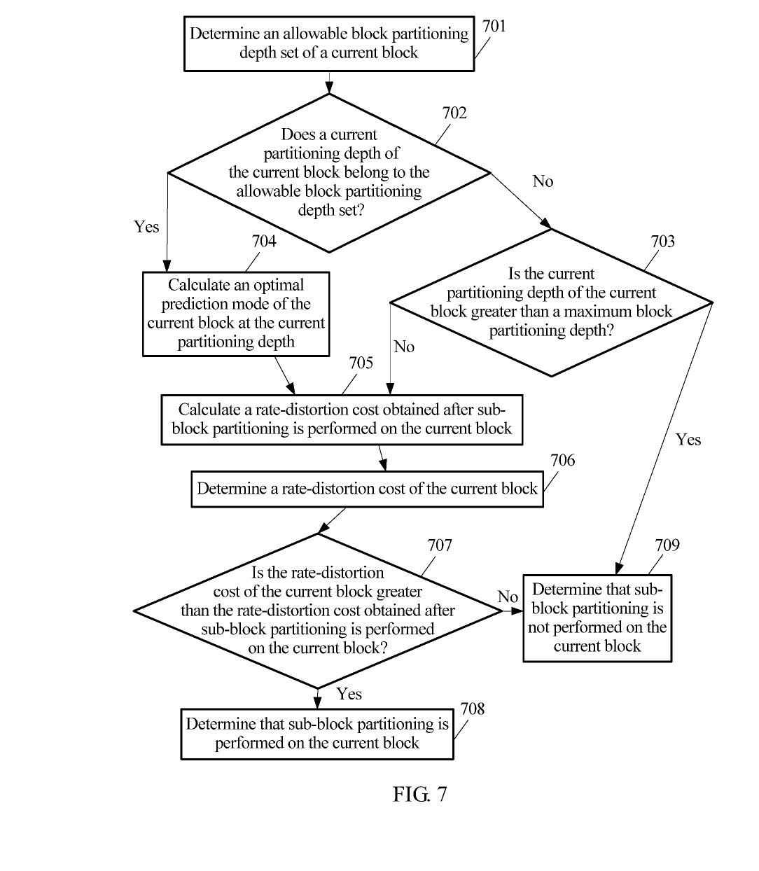

Referring to FIG. 7, FIG. 7 is a schematic flowchart of another method for determining a block partitioning manner in video coding according to an embodiment of the present disclosure. As shown in FIG. 7, another method for determining a block partitioning manner in video coding according to this embodiment of the present disclosure may include the following content.

Step 701: Determine an allowable block partitioning depth set of a current block.

In some embodiments of the present disclosure, the allowable block partitioning depth set may be: a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 7, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 7, 4, 5, 6, 7, or another value.

Step 702: Determine whether a current partitioning depth of the current block belongs to the allowable block partitioning depth set.

If the current partitioning depth of the current block belongs to the allowable block partitioning depth set, go to step 704.

If the current partitioning depth of the current block does not belong to the allowable block partitioning depth set, go to step 703.

Step 703: Determine whether the current partitioning depth of the current block is greater than a maximum block partitioning depth in the allowable block partitioning depth set.

If the current partitioning depth of the current block is greater than a maximum block partitioning depth in the allowable block partitioning depth set, go to step 709.

If the current partitioning depth of the current block is not greater than a maximum block partitioning depth in the allowable block partitioning depth set, go to step 705.

Step 704: Calculate an optimal prediction mode of the current block at the current partitioning depth.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 705: Calculate a rate-distortion cost obtained after sub-block partitioning is performed on the current block.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes: using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block; or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 7, 4, or another value)), or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 7, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 706: Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 707: Determine whether the rate-distortion cost of the current block is greater than the rate-distortion cost obtained after sub-block partitioning is performed on the current block.

If yes, go to step 708.

If no, go to step 709.

Step 708: Determine that sub-block partitioning is performed on the current block.

Step 709: Determine that sub-block partitioning is not performed on the current block.

It can be seen that in the solution of this embodiment, an encoding side first determines an allowable block partitioning depth set of a current block in a video coding process; and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

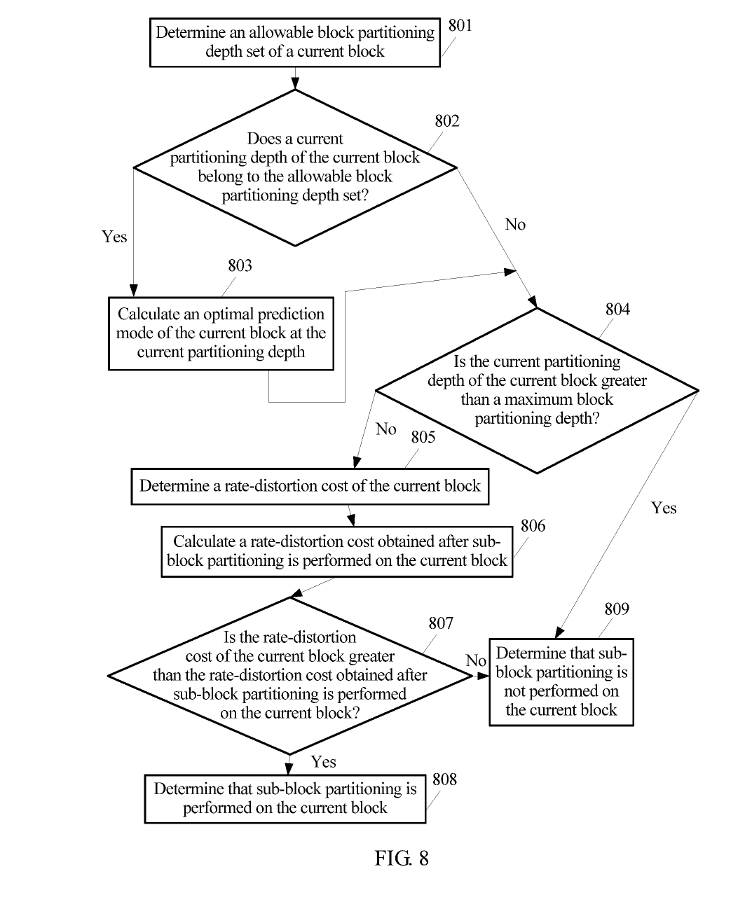

Referring to FIG. 8, FIG. 8 is a schematic flowchart of another method for determining a block partitioning manner in video coding according to an embodiment of the present disclosure. As shown in FIG. 8, another method for determining a block partitioning manner in video coding according to this embodiment of the present disclosure may include the following content.

Step 801: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 8, 5, 6, 7, or another value.

Step 802: Determine whether a current partitioning depth of the current block belongs to the allowable block partitioning depth set.

If yes, go to step 803.

If no, go to step 804.

Step 803: Calculate an optimal prediction mode of the current block at the current partitioning depth, and go to step 804.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 804: Determine whether the current partitioning depth of the current block is greater than a maximum block partitioning depth in the allowable block partitioning depth set.

If yes, go to step 809.

If no, go to step 805.

Step 805: Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 806: Calculate a rate-distortion cost obtained after sub-block partitioning is performed on the current block.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 807: Determine whether the rate-distortion cost of the current block is greater than the rate-distortion cost obtained after sub-block partitioning is performed on the current block.

If the rate-distortion cost of the current block is greater than the rate-distortion cost obtained after sub-block partitioning is performed on the current block, go to step 808.

If the rate-distortion cost of the current block is not greater than the rate-distortion cost obtained after sub-block partitioning is performed on the current block, go to step 809.

Step 808: Determine that sub-block partitioning is performed on the current block.

Step 809: Determine that sub-block partitioning is not performed on the current block.

It can be seen that in the solution of this embodiment, an encoding side first determines an allowable block partitioning depth set of a current block in a video coding process; and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

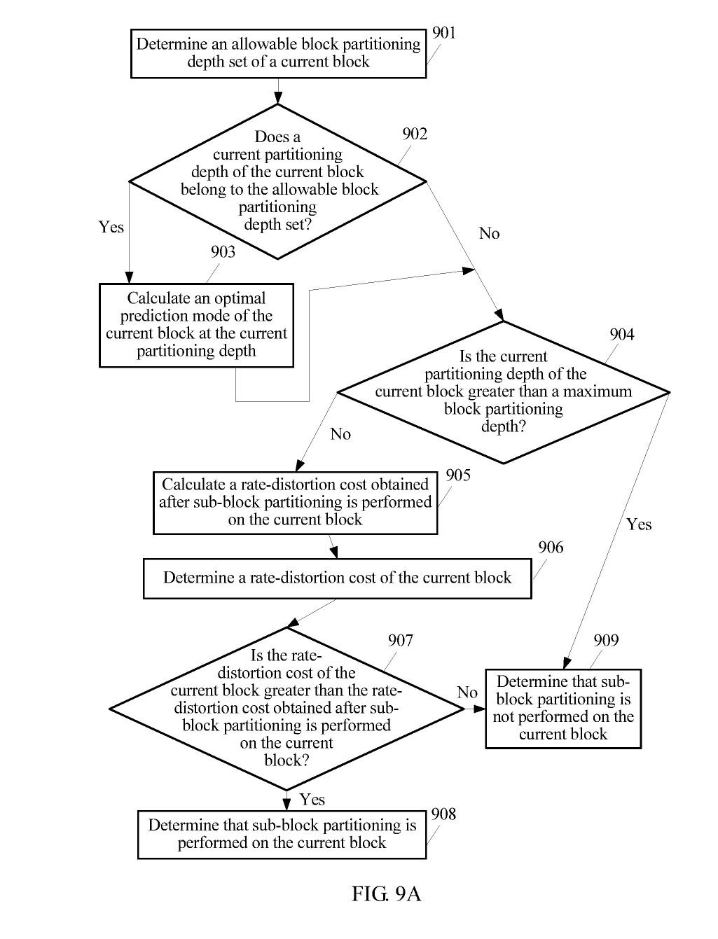

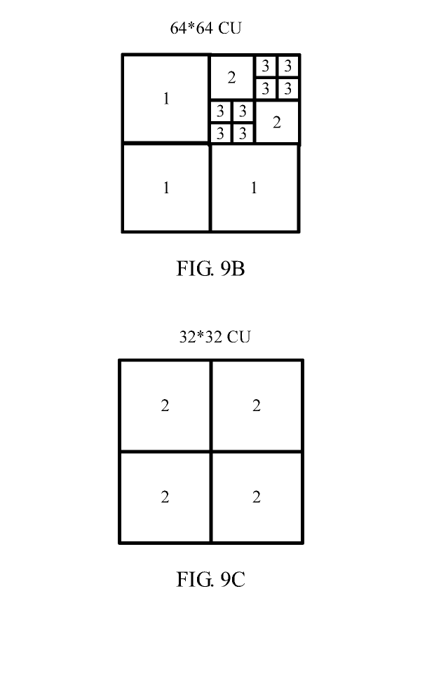

Referring to FIG. 9A, FIG. 9A is a schematic flowchart of another method for determining a block partitioning manner in video coding according to an embodiment of the present disclosure. As shown in FIG. 9A, another method for determining a block partitioning manner in video coding according to this embodiment of the present disclosure may include the following content:

Step 901: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

Step 902: Determine whether a current partitioning depth of the current block belongs to the allowable block partitioning depth set.

If yes, go to step 903.

If no, go to step 904.

Step 903: Calculate an optimal prediction mode of the current block at the current partitioning depth, and go to step 904.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 904: Determine whether the current partitioning depth of the current block is greater than a maximum block partitioning depth in the allowable block partitioning depth set.

If yes, go to step 909.

If no, go to step 905.

Step 905: Calculate a rate-distortion cost obtained after sub-block partitioning is performed on the current block.

In some embodiments of the present disclosure, the calculating a rate-distortion cost obtained after sub-block partitioning is performed on the current block may include: calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes: using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block, or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

Step 906: Determine a rate-distortion cost of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

Step 907: Determine whether the rate-distortion cost of the current block is greater than the rate-distortion cost obtained after sub-block partitioning is performed on the current block.

If yes, go to step 908.

If no, go to step 909.

Step 908: Determine that sub-block partitioning is performed on the current block.

Step 909: Determine that sub-block partitioning is not performed on the current block.

It can be seen that in the solution of this embodiment, an encoding side first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

The following uses some specific data for analysis.

It is concluded by means of statistical analysis that block partitioning depths used most frequently in a common picture are generally only a few CU sizes, for example, generally, two CU sizes may take up an overwhelming majority of a usage proportion, while other several CU sizes take up a relatively small proportion.

Therefore, an average expected value (E_{Depth}) of a block division depth can be estimated:

E_{Depth}=Σᵢ₌₀³i×Ratio_{CU}_{_}ᵢ

where in the foregoing formula, i represents a block division depth, Ratio represents a proportion of blocks with a division depth i, and E_{Depth} represents an average expected value of a block division depth in a picture.

Based on the foregoing formula, an optimal expected value under different coding configurations can be estimated. For example, a most possible expected value of a partitioning depth of an I frame is 2.34, and therefore a most possible division depth is an integer greater than 2. If an original size of a picture block is 64*64, an 8*8 CU size is an optimal size after division. Other configuration scenarios are analogous.

Therefore, according to a frame type and a coding configuration, one frame-level allowable block partitioning depth set CUControlSet={i,j} of a current block can be established, where i and j are two block partitioning depths that are used most frequently in latest coding. The frame-level allowable block partitioning depth set can be updated according to a coded frame during coding because the block partitioning depths that are used most frequently may change as coding is performed.

In addition, the current block (for example, a current coding unit) has a corresponding prediction block in a prediction frame, and a division type of the prediction block is known to the current block. Therefore, the prediction block can be used as a block partitioning prediction reference for the current block. Therefore, a block division structure of the prediction block of the current block may be used to establish one block-level allowable block partitioning depth set of the current block: CUPredictSet={depths in co-located CU}.

For example, as shown in FIG. 9B, if a size of the prediction block of the current block is 64*64, and a division structure of the prediction block is shown in FIG. 9B, the block-level allowable block partitioning depth set of the current block is {1, 2, 3}, indicating that there are three block partitioning depths. If a size of the prediction block is 32*32, and a division structure of the prediction block is shown in FIG. 9C, the block-level allowable block partitioning depth set of the current block is {2}, indicating that there is one block partitioning depth. The block-level allowable block partitioning depth set changes according to a CU.

With reference to the block-level allowable block partitioning depth set and the frame-level allowable block partitioning depth set and according to a relationship between a current block division depth and an allowable block division depth set, whether sub-block partitioning is performed on the current block is determined. From a statistical perspective, with reference to picture content and obtained coding information, a frame-level allowable block division depth set and a CU-level allowable block division depth set are established, so as to adaptively implement block division control on the current block, which helps to avoid unnecessary rate-distortion calculation, thereby helping to reduce coding calculation complexity.

The following provides a test result. Test results of an HM12.0 common test sequence under an all intra (AI) frame configuration, a low delay bidirectional (LDB) frame configuration, and a random access (RA) configuration respectively are as follows:

TABLE 1

| | | | Decrease |
|---|---|---|---|
| Picture | | BD-Rate increasing in | in coding |
| size | Test sequence | average, BD-Rate (%) | time (%) |
| 4K | Traffic | 1.6 | 39.9 |
| | PeopleOnStreet | 1.8 | 31.8 |
| 1080P | Kimono | 1.5 | 59.3 |
| | ParkScene | 1.2 | 39.5 |
| | Cactus | 1.3 | 37.2 |
| | BasketballDrive | 2.9 | 51.1 |
| | BQTerrace | 0.4 | 23.3 |
| WVGA | BasketballDrill | 1.4 | 32.9 |
| | BQMall | 0.6 | 24.6 |
| | PartyScene | 0.0 | 20.2 |
| | RaceHorsesC | 1.9 | 37.8 |
| WQVGA | BasketballPass | 1.3 | 33.3 |
| | BlowingBubbles | 0.0 | 19.1 |
| | BQSquare | 0.2 | 22.7 |
| | RaceHorses | 0.4 | 22.4 |
| 720P | FourPeople | 1.5 | 45.6 |
| | Johnny | 2.1 | 51.7 |
| | KristenAndSara | 1.6 | 50.1 |

| | | |
|---|---|---|
| Average | 1.2 | 35.7 |

TABLE 2

| | | | Decrease in |
|---|---|---|---|
| | | Increase in average | coding |
| Picture size | Test sequence | bitrate, BD-Rate (%) | time (%) |
| 1080P | Kimono | 1.3 | 41.6 |
| | ParkScene | 2.1 | 33.0 |
| | Cactus | 4.4 | 36.2 |
| | BasketballDrive | 4.9 | 34.7 |
| | BQTerrace | 1.2 | 38.3 |
| WVGA | BasketballDrill | 6.2 | 36.4 |
| | BQMall | 6.1 | 33.7 |
| | PartyScene | 2.3 | 29.0 |
| | RaceHorsesC | 3.5 | 32.2 |
| WQVGA | BasketballPass | 4.9 | 34.5 |
| | BlowingBubbles | 1.3 | 30.1 |
| | BQSquare | 1.9 | 30.2 |
| | RaceHorses | 3.9 | 28.0 |
| 720P | FourPeople | 3.6 | 43.5 |
| | Johnny | 1.9 | 44.5 |
| | KristenAndSara | 1.6 | 44.2 |

| | | |
|---|---|---|
| Average | 3.2 | 35.6 |

TABLE 3

| | | | Decrease |
|---|---|---|---|
| Picture | | Increase in average | in coding |
| size | Test sequence | bitrate, BD-Rate (%) | time (%) |
| 4K | Traffic | 1.4 | 35.1 |
| | PeopleOnStreet | 2.1 | 27.0 |
| 1080P | Kimono | 0.9 | 35.9 |
| | ParkScene | 1.6 | 29.3 |
| | Cactus | 2.0 | 31.3 |
| | BasketballDrive | 3.0 | 33.2 |
| | BQTerrace | 0.8 | 34.6 |
| WVGA | BasketballDrill | 3.7 | 32.6 |
| | BQMall | 4.2 | 30.5 |
| | PartyScene | 1.5 | 28.2 |
| | RaceHorsesC | 2.2 | 27.7 |
| WQVGA | BasketballPass | 2.3 | 30.9 |
| | BlowingBubbles | 0.7 | 31.7 |
| | BQSquare | 0.8 | 28.7 |
| | RaceHorses | 1.7 | 23.9 |

| | | |
|---|---|---|
| Average | 1.9 | 30.7 |

Table 1 is a test result under the AI configuration, Table 2 is a test result under the LDB frame configuration, and Table 3 is a test result under the RA configuration. Under the AI, LDB, and RA configurations, calculation complexity can be reduced by 35.7%, 35.6%, and 30.7% respectively, and an average bitrate increase is only 1.2% under the AI.

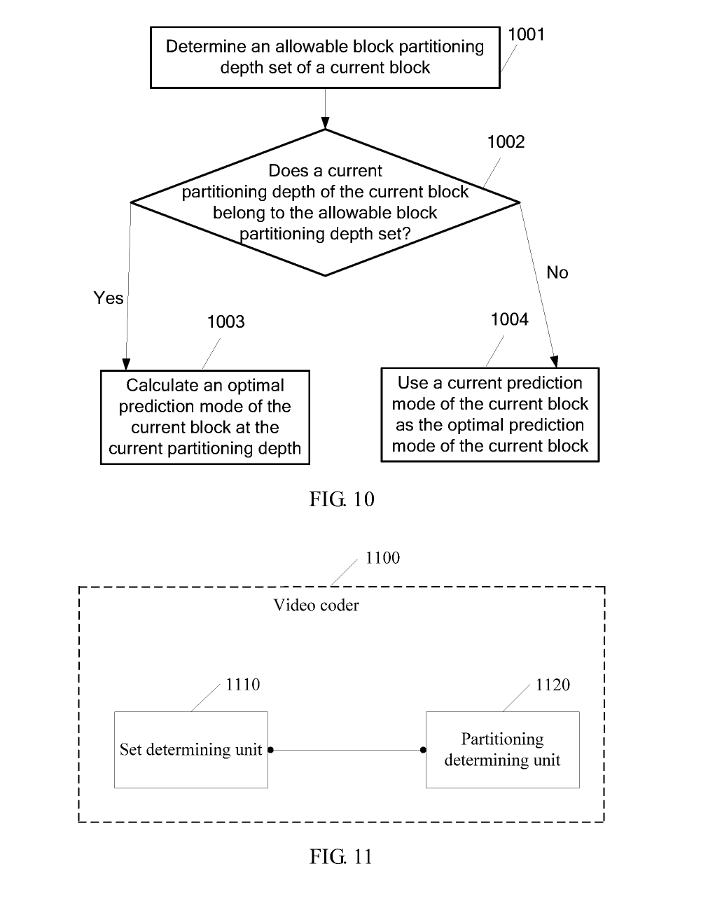

Referring to FIG. 10, FIG. 10 is a schematic flowchart of another method for determining an optimal prediction mode of a current block in video coding according to an embodiment of the present disclosure. As shown in FIG. 10, another method for determining an optimal prediction mode of a current block in video coding according to this embodiment of the present disclosure may include the following content:

Step 1001: Determine an allowable block partitioning depth set of a current block.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

Step 1002: Determine whether a current partitioning depth of the current block belongs to the allowable block partitioning depth set.

If yes, go to step 1003.

If no, go to step 1004.

Step 1003: Calculate an optimal prediction mode of the current block at the current partitioning depth.

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth), or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

Step 1004: Use a current prediction mode of the current block as the optimal prediction mode of the current block.

In some embodiments of the present disclosure, if the current partitioning depth of the current block belongs to the allowable block partitioning depth set, the rate-distortion cost of the current block is a rate-distortion cost of the current block in the optimal prediction mode, or if the current partitioning depth of the current block is less than a minimum block partitioning depth in the allowable block partitioning depth set, the rate-distortion cost of the of the current block is a rate-distortion cost of the current block in a current prediction mode (in this case, it may be considered that the current prediction mode of the cellular network is used as the optimal prediction mode of the cellular network at the current partitioning depth).

In some embodiments of the present disclosure, the determining an optimal prediction mode of the current block according to the allowable block partitioning depth set may include: if the current partitioning depth of the current block belongs to the allowable block partitioning depth set, obtaining the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, if the current partitioning depth of the current block belongs to the allowable block partitioning depth set, a rate-distortion cost of the current block may be a rate-distortion cost of the current block in the optimal prediction mode; and/or if the current partitioning depth of the current block is less than a minimum block partitioning depth in the allowable block partitioning depth set, the rate-distortion cost of the current block is a rate-distortion cost of the current block in the current prediction mode.

In some embodiments of the present disclosure, the calculating a rate-distortion cost obtained after sub-block partitioning is performed on the current block may include: calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes: using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block; or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

That the current block is a CU is used as an example. In the HEVC standard, a CU is further partitioned generally in a quadtree partitioning manner, for example, when an upper-level CU is divided into Sub-CUs, a block split_flag is used to indicate whether a current Sub-CU is further partitioned into smaller Sub-CUs. For example, when a value of the split_flag is “1”, it indicates that the current Sub-CU is further partitioned into smaller Sub-CUs; or when the value of the split_flag is “0”, it indicates that the current Sub-CU stops being partitioned. Certainly, the split_flag may also be another value to indicate the block partitioning manner of the current block.

It can be seen that in the solution of this embodiment, an encoding side first determines an allowable block partitioning depth set of a current block in a video coding process, and then determines, according to the allowable block partitioning depth set, an optimal prediction mode of the current block. The encoding side can determine the optimal prediction mode of the current block according to the allowable block partitioning depth set of the current block, instead of determining the optimal prediction mode of the current block by calculating performance parameters such as rate-distortion costs of multiple blocks each time, thereby helping to reduce calculation complexity in determining the optimal prediction mode of the current block in the video coding process, and further helps to reduce calculation complexity in determining a block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

The following further provides a related apparatus that is used to implement the foregoing solutions.

Referring to FIG. 11, an embodiment of the present disclosure provides a video coder 1100, which may include a set determining unit 1110 and a partitioning determining unit 1120.

The set determining unit 1110 is configured to determine an allowable block partitioning depth set of a current block.

The partitioning determining unit 1120 is configured to determine, according to the allowable block partitioning depth set, whether sub-block partitioning is performed on the current block at a current partitioning depth.

In some embodiments of the present disclosure, if the current partitioning depth of the current block does not belong to the allowable block partitioning depth set, the partitioning determining unit 1120 does not calculate an optimal prediction mode of the current block at the current partitioning depth.

In some embodiments of the present disclosure, the partitioning determining unit 1120 is further configured to: if the current partitioning depth of the current block is greater than a maximum block partitioning depth in the allowable block partitioning depth set, determine that sub-block partitioning is not performed on the current block.

In some embodiments of the present disclosure, the partitioning determining unit 1120 is further configured to, if the current partitioning depth of the current block belongs to the allowable block partitioning depth set, or the current partitioning depth of the current block is less than a minimum block partitioning depth in the allowable block partitioning depth set, calculate a rate-distortion cost obtained after sub-block partitioning is performed on the current block, and if a rate-distortion cost of the current block is less than or equal to the rate-distortion cost obtained after sub-block partitioning is performed on the current block, determine that sub-block partitioning is not performed on the current block, or if a rate-distortion cost of the current block is greater than the rate-distortion cost obtained after sub-block partitioning is performed on the current block, determine that sub-block partitioning is performed on the current block.

In some embodiments of the present disclosure, if the current partitioning depth of the current block belongs to the allowable block partitioning depth set, the rate-distortion cost of the current block is a rate-distortion cost of the current block in the optimal prediction mode, and/or if the current partitioning depth of the current block is less than the minimum block partitioning depth in the allowable block partitioning depth set, the rate-distortion cost of the current block is a rate-distortion cost of the current block in a current prediction mode.

In some embodiments of the present disclosure, the optimal prediction mode of the current block is a prediction mode with a minimum rate-distortion cost in all optional prediction modes of the current block at the current partitioning depth, or a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, with respect to the calculating a rate-distortion cost obtained after sub-block partitioning is performed on the current block, the partitioning determining unit 1120 is further configured to calculate, based on rate-distortion costs of sub-blocks into which the current block is partitioned, the rate-distortion cost obtained after sub-block partitioning is performed on the current block.

In some embodiments of the present disclosure, with respect to the calculating, based on rate-distortion costs of sub-blocks into which the current block is partitioned, the rate-distortion cost obtained after sub-block partitioning is performed on the current block, the partitioning determining unit 1120 may be further configured to use a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block, or obtain, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtain, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)), or obtain, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

In some embodiments of the present disclosure, the allowable block partitioning depth set is a frame-level allowable block partitioning depth set, a block-level allowable block partitioning depth set, or a union set of a frame-level allowable block partitioning depth set and a block-level allowable block partitioning depth set.

In some embodiments of the present disclosure, the frame-level allowable block partitioning depth set includes M block partitioning depths that are used most frequently within a current statistical period or until a current moment in a coded video frame that is of a same type as a video frame to which the current block belongs, where M is a positive integer.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame; or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period is a length of one GOP, an interval between two adjacent intra-frames, an interval between two non-adjacent intra-frames, or an interval between any two intra-frames.

In some embodiments of the present disclosure, the block-level allowable block partitioning depth set includes K block partitioning depths used by a prediction block of the current block, where K is a positive integer.

It may be understood that functions of all function modules of the video coder 1100 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coder 1100 first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

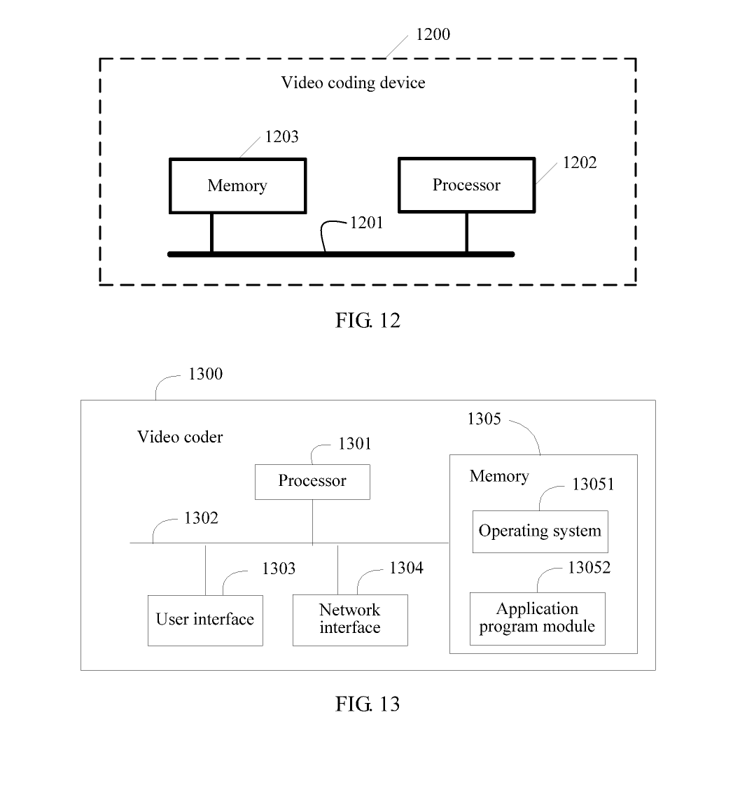

Referring to FIG. 12, FIG. 12 is a schematic diagram of a video coding device 1200 according to an embodiment of the present disclosure. The video coding device 1200 may include at least one bus 1201, at least one processor 1202 connected to the bus 1201, and at least one memory 1203 connected to the bus 1201.

The processor 1202 invokes, using the bus 1201, code stored in the memory 1203, so as to determine an allowable block partitioning depth set of a current block, and determine, according to the allowable block partitioning depth set, whether sub-block partitioning is performed on the current block at a current partitioning depth.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame; or the set moment may be a latest moment of coding a type or several specific types of video frames in a video to which a video frame belongs, where the current block belongs to the video frame; or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer); or the P related blocks may include the reference block of the current block (in this scenario, P is a positive integer equal to 1); or the P related blocks may include at least one adjacent block in four adjacent blocks of the reference block of the current block (in this scenario, P is a positive integer); or the P related blocks may include the reference block of the current block and at least one adjacent block in four adjacent blocks of the current block (in this scenario, P is a positive integer greater than 1); or the P related blocks may include the reference block of the current block and at least one adjacent block in four adjacent blocks of the reference block (in this scenario, P is a positive integer greater than 1); or the P related blocks may include at least one adjacent block in four adjacent blocks of the current block and at least one adjacent block in four adjacent blocks of the reference block of the current block (in this scenario, P is a positive integer greater than 1); or the P related blocks may include the at least one adjacent block of the current block, the reference block of the current block, and the at least one adjacent block of the reference block (in this scenario, P is a positive integer greater than 2).

In some embodiments of the present disclosure, if the current partitioning depth of the current block does not belong to the allowable block partitioning depth set, the processor 1202 may not calculate the optimal prediction mode of the current block at the current partitioning depth. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, with respect to the determining, according to the allowable block partitioning depth set, whether sub-block partitioning is performed on the current block at a current partitioning depth, the processor 1202 may be further configured to, if the current partitioning depth of the current block is greater than a maximum block partitioning depth in the allowable block partitioning depth set, determine that sub-block partitioning is not performed on the current block.

In some embodiments of the present disclosure, with respect to the determining, according to the allowable block partitioning depth set, whether sub-block partitioning is performed on the current block at a current partitioning depth, the processor 1202 may be further configured to, if the current partitioning depth of the current block belongs to the allowable block partitioning depth set, or the current partitioning depth of the current block is less than a minimum block partitioning depth in the allowable block partitioning depth set, calculate a rate-distortion cost obtained after sub-block partitioning is performed on the current block, and if a rate-distortion cost of the current block is less than or equal to the rate-distortion cost obtained after sub-block partitioning is performed on the current block, determine that sub-block partitioning is not performed on the current block; or if a rate-distortion cost of the current block is greater than the rate-distortion cost obtained after sub-block partitioning is performed on the current block, determine that sub-block partitioning is performed on the current block.

In some embodiments of the present disclosure, if the current partitioning depth of the current block belongs to the allowable block partitioning depth set, the rate-distortion cost of the current block is a rate-distortion cost of the current block in the optimal prediction mode, and/or if the current partitioning depth of the current block is less than the minimum block partitioning depth in the allowable block partitioning depth set, the rate-distortion cost of the current block is a rate-distortion cost of the current block in a current prediction mode.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, with respect to the calculating a rate-distortion cost obtained after sub-block partitioning is performed on the current block, the processor 1202 may be further configured to calculate, based on rate-distortion costs of all sub-blocks into which the current block is partitioned, the rate-distortion cost obtained after sub-block partitioning is performed on the current block.

In some embodiments of the present disclosure, with respect to the calculating, based on rate-distortion costs of all sub-blocks into which the current block is partitioned, the rate-distortion cost obtained after sub-block partitioning is performed on the current block, the processor 1202 may be further configured to use a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block; or obtain, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtain, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtain, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

It may be understood that functions of all function modules of the video coding device 1200 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coding device 1200 first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

Referring to FIG. 13, FIG. 13 is a schematic structural block diagram of a video coder 1300 according to another embodiment of the present disclosure.

The video coder 1300 may include at least one processor 1301, at least one network interface 1304, a memory 1305, and at least one communications bus 1302. The communications bus 1302 is configured to implement connection and communication between these components. Optionally, the video coder 1300 includes a user interface 1303, including a display (for example, a touchscreen, a liquid crystal display, a holographic imaging unit or a projector), a clicking/tapping device (for example, a mouse, a trackball, a touch panel, or a touchscreen), a camera and/or a pickup apparatus, and the like.

The memory 1305 may include a read-only memory and a random access memory, and provide an instruction and data to the processor 1301. A part of the memory 1305 may further include a non-volatile random access memory.

In some implementation manners, the memory 1305 stores the following elements, an executable module or a data structure, or a subset thereof, or an extension set thereof: an operating system 13051, which includes various system programs and is configured to implement various basic services and process a hardware-based task, and an application program module 13052, which includes various application programs and is configured to implement various application services.

The application program module 13052 includes but is not limited to a set determining unit 1110 and a partitioning determining unit 1120.

In this embodiment of the present disclosure, by invoking a program or an instruction stored in the memory 1305, the processor 1301 is configured to determine an allowable block partitioning depth set of a current block, and determine, according to the allowable block partitioning depth set, whether sub-block partitioning is performed on the current block at a current partitioning depth.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer); or the P related blocks may include the reference block of the current block (in this scenario, P is a positive integer equal to 1); or the P related blocks may include at least one adjacent block in four adjacent blocks of the reference block of the current block (in this scenario, P is a positive integer); or the P related blocks may include the reference block of the current block and at least one adjacent block in four adjacent blocks of the current block (in this scenario, P is a positive integer greater than 1); or the P related blocks may include the reference block of the current block and at least one adjacent block in four adjacent blocks of the reference block (in this scenario, P is a positive integer greater than 1); or the P related blocks may include at least one adjacent block in four adjacent blocks of the current block and at least one adjacent block in four adjacent blocks of the reference block of the current block (in this scenario, P is a positive integer greater than 1); or the P related blocks may include the at least one adjacent block of the current block, the reference block of the current block, and the at least one adjacent block of the reference block (in this scenario, P is a positive integer greater than 2).

In some embodiments of the present disclosure, if the current partitioning depth of the current block does not belong to the allowable block partitioning depth set, the processor 1301 may not calculate the optimal prediction mode of the current block at the current partitioning depth. The optimal prediction mode of the current block may be a prediction mode with a minimum rate-distortion cost in all optional prediction modes of the current block at the current partitioning depth (that is, to determine the optimal prediction mode of the current block at the current partitioning depth, furthermore, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, furthermore, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, with respect to the determining, according to the allowable block partitioning depth set, whether sub-block partitioning is performed on the current block at a current partitioning depth, the processor 1301 may be further configured to, if the current partitioning depth of the current block is greater than a maximum block partitioning depth in the allowable block partitioning depth set, determine that sub-block partitioning is not performed on the current block.

In some embodiments of the present disclosure, with respect to the determining, according to the allowable block partitioning depth set, whether sub-block partitioning is performed on the current block at a current partitioning depth, the processor 1301 may be further configured to, if the current partitioning depth of the current block belongs to the allowable block partitioning depth set, or the current partitioning depth of the current block is less than a minimum block partitioning depth in the allowable block partitioning depth set, calculate a rate-distortion cost obtained after sub-block partitioning is performed on the current block, and if a rate-distortion cost of the current block is less than or equal to the rate-distortion cost obtained after sub-block partitioning is performed on the current block, determine that sub-block partitioning is not performed on the current block, or if a rate-distortion cost of the current block is greater than the rate-distortion cost obtained after sub-block partitioning is performed on the current block, determine that sub-block partitioning is performed on the current block.

In some embodiments of the present disclosure, if the current partitioning depth of the current block belongs to the allowable block partitioning depth set, the rate-distortion cost of the current block is a rate-distortion cost of the current block in the optimal prediction mode, and/or if the current partitioning depth of the current block is less than the minimum block partitioning depth in the allowable block partitioning depth set, the rate-distortion cost of the current block is a rate-distortion cost of the current block in a current prediction mode.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, with respect to the calculating a rate-distortion cost obtained after sub-block partitioning is performed on the current block, the processor 1301 is further configured to calculate, based on rate-distortion costs of all sub-blocks into which the current block is partitioned, the rate-distortion cost obtained after sub-block partitioning is performed on the current block.

In some embodiments of the present disclosure, with respect to the calculating, based on rate-distortion costs of all sub-blocks into which the current block is partitioned, the rate-distortion cost obtained after sub-block partitioning is performed on the current block, the processor 1301 may be further configured to use a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block; or obtain, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtain, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtain, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

It may be understood that functions of all function modules of the video coder 1300 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coder device 1300 first determines an allowable block partitioning depth set of a current block in a video coding process, and then determines, according to the allowable block partitioning depth set, whether sub-block partitioning is performed on the current block at a current partitioning depth. The encoding side can determine a block partitioning manner of the current block according to the allowable block partitioning depth set of the current block, instead of determining the block partitioning manner of the current block by calculating performance parameters such as rate-distortion costs of multiple blocks each time, thereby helping to reduce calculation complexity in determining the block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

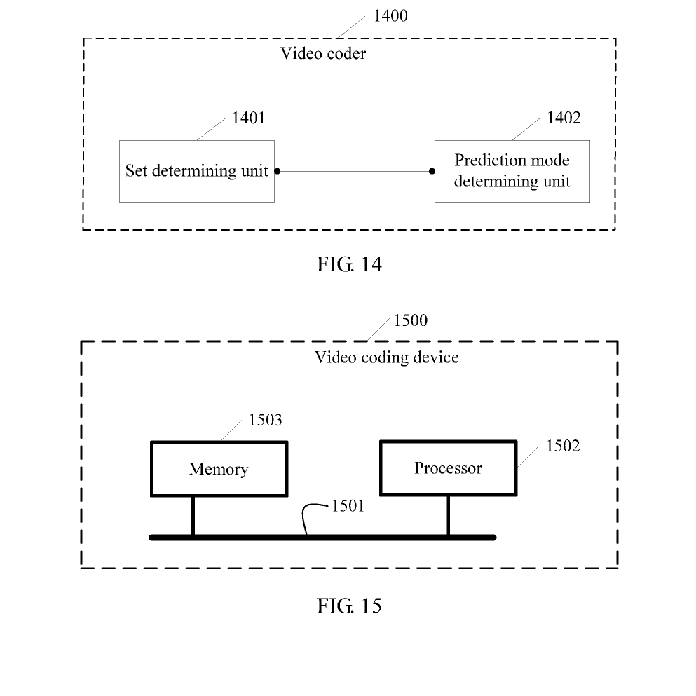

Referring to FIG. 14, an embodiment of the present disclosure provides a video coder 1400, which may include a set determining unit 1401 and a prediction mode determining unit 1402.

The set determining unit 1401 is configured to determine an allowable block partitioning depth set of a current block.

The prediction mode determining unit 1402 is configured to determine an optimal prediction mode of the current block according to the allowable block partitioning depth set.

In some embodiments of the present disclosure, if a current partitioning depth of the current block does not belong to the allowable block partitioning depth set, the prediction mode determining unit 1402 does not calculate an optimal prediction mode of the current block at the current partitioning depth.

In some embodiments of the present disclosure, the prediction mode determining unit 1402 is further configured to, if the current partitioning depth of the current block does not belong to the allowable block partitioning depth set, use a current prediction mode of the current block as the optimal prediction mode of the current block.

In some embodiments of the present disclosure, the prediction mode determining unit 1402 is further configured to, if the current partitioning depth of the current block belongs to the allowable block partitioning depth set, obtain the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, the allowable block partitioning depth set is a frame-level allowable block partitioning depth set, a block-level allowable block partitioning depth set, or a union set of a frame-level allowable block partitioning depth set and a block-level allowable block partitioning depth set.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period is a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

In some embodiments of the present disclosure, if the current partitioning depth of the current block belongs to the allowable block partitioning depth set, a rate-distortion cost of the current block may be a rate-distortion cost of the current block in the optimal prediction mode, and/or if the current partitioning depth of the current block is less than a minimum block partitioning depth in the allowable block partitioning depth set, the rate-distortion cost of the current block is a rate-distortion cost of the current block in the current prediction mode.

In some embodiments of the present disclosure, the calculating a rate-distortion cost obtained after sub-block partitioning is performed on the current block may include calculating, based on rate-distortion costs of all sub-blocks into which the current block is partitioned, the rate-distortion cost obtained after sub-block partitioning is performed on the current block.

In some embodiments of the present disclosure, the calculating, based on rate-distortion costs of all sub-blocks into which the current block is partitioned, the rate-distortion cost obtained after sub-block partitioning is performed on the current block includes using a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or using the sum of rate-distortion costs of all sub-blocks into which the current block is partitioned as the rate-distortion cost obtained after sub-block partitioning is performed on the current block; or obtaining, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)), or obtaining, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)), or obtaining, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

It may be understood that functions of all function modules of the video coder 1400 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coder 1400 first determines an allowable block partitioning depth set of a current block in a video coding process, and then determines, according to the allowable block partitioning depth set, an optimal prediction mode of the current block. The encoding side can determine the optimal prediction mode of the current block according to the allowable block partitioning depth set of the current block, instead of determining the optimal prediction mode of the current block by calculating performance parameters such as rate-distortion costs of multiple blocks each time, thereby helping to reduce calculation complexity in determining the optimal prediction mode of the current block in the video coding process, and further helps to reduce calculation complexity in determining a block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

Referring to FIG. 15, FIG. 15 is a schematic diagram of a video coding device 1500 according to an embodiment of the present disclosure. The video coding device 1500 may include at least one bus 1501, at least one processor 1502 connected to the bus 1501, and at least one memory 1503 connected to the bus 1501.

The processor 1502 invokes, using the bus 1501, code stored in the memory 1503, so as to: determine an allowable block partitioning depth set of a current block in a video coding process, and then determine an optimal prediction mode of the current block according to the allowable block partitioning depth set.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame; or the set moment may be a latest moment of coding a type or several specific types of video frames in a video to which a video frame belongs, where the current block belongs to the video frame; or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer); or the P related blocks may include the reference block of the current block (in this scenario, P is a positive integer equal to 1); or the P related blocks may include at least one adjacent block in four adjacent blocks of the reference block of the current block (in this scenario, P is a positive integer); or the P related blocks may include the reference block of the current block and at least one adjacent block in four adjacent blocks of the current block (in this scenario, P is a positive integer greater than 1); or the P related blocks may include the reference block of the current block and at least one adjacent block in four adjacent blocks of the reference block (in this scenario, P is a positive integer greater than 1); or the P related blocks may include at least one adjacent block in four adjacent blocks of the current block and at least one adjacent block in four adjacent blocks of the reference block of the current block (in this scenario, P is a positive integer greater than 1); or the P related blocks may include the at least one adjacent block of the current block, the reference block of the current block, and the at least one adjacent block of the reference block (in this scenario, P is a positive integer greater than 2).

In some embodiments of the present disclosure, if a current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, further, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, further, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, with respect to the determining an optimal prediction mode of the current block according to the allowable block partitioning depth set, the processor 1502 may be further configured to, if the current partitioning depth of the current block does not belong to the allowable block partitioning depth set, use a current prediction mode of the current block as the optimal prediction mode of the current block.

In some embodiments of the present disclosure, with respect to the determining the optimal prediction mode of the current block according to the allowable block partitioning depth set, the processor 1502 may be further configured to, if the current partitioning depth of the current block belongs to the allowable block partitioning depth set, obtain the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, if the current partitioning depth of the current block belongs to the allowable block partitioning depth set, a rate-distortion cost of the current block may be a rate-distortion cost of the current block in the optimal prediction mode; and/or if the current partitioning depth of the current block is less than a minimum block partitioning depth in the allowable block partitioning depth set, the rate-distortion cost of the current block is a rate-distortion cost of the current block in the current prediction mode.

In some embodiments of the present disclosure, with respect to the calculating a rate-distortion cost obtained after sub-block partitioning is performed on the current block, the processor 1502 may be further configured to calculate, based on rate-distortion costs of all sub-blocks into which the current block is partitioned, the rate-distortion cost obtained after sub-block partitioning is performed on the current block.

In some embodiments of the present disclosure, with respect to the calculating, based on rate-distortion costs of all sub-blocks into which the current block is partitioned, the rate-distortion cost obtained after sub-block partitioning is performed on the current block, the processor 1502 may be further configured to use a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block; or use the sum of rate-distortion costs of all sub-blocks into which the current block is partitioned as the rate-distortion cost obtained after sub-block partitioning is performed on the current block; or obtain, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtain, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtain, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

It may be understood that functions of all function modules of the video coding device 1500 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coding device 1500 first determines an allowable block partitioning depth set of a current block in a video coding process; and then determines, according to the allowable block partitioning depth set, an optimal prediction mode of the current block. The encoding side can determine the optimal prediction mode of the current block according to the allowable block partitioning depth set of the current block, instead of determining the optimal prediction mode of the current block by calculating performance parameters such as rate-distortion costs of multiple blocks each time, thereby helping to reduce calculation complexity in determining the optimal prediction mode of the current block in the video coding process, and further helps to reduce calculation complexity in determining a block partitioning manner of the current block in the video coding process.

Further, the allowable block partitioning depth set of the current block may be: a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

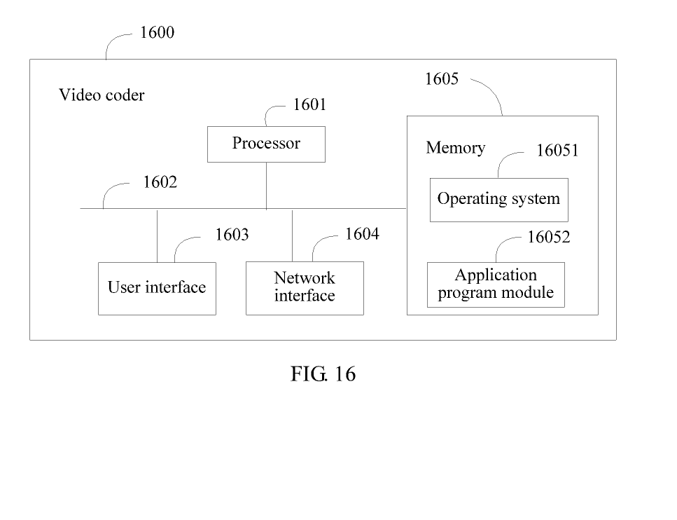

Referring to FIG. 16, FIG. 16 is a structural block diagram of a video coder 1600 according to another embodiment of the present disclosure. The video coder 1600 may include at least one processor 1601, at least one network interface 1604, a memory 1605, and at least one communications bus 1602. The communications bus 1602 is configured to implement connection and communication between these components. Optionally, the video coder 1600 includes a user interface 1603, including a display (for example, a touchscreen, a liquid crystal display, a holographic imaging unit or a projector), a clicking/tapping device (for example, a mouse, a trackball, a touch panel, or a touchscreen), a camera and/or a pickup apparatus, and the like.

The memory 1605 may include a read-only memory and a random access memory, and provide an instruction and data to the processor 1601. A part of the memory 1602 may further include a non-volatile random access memory.

In some implementation manners, the memory 1605 stores the following elements, an executable module or a data structure, or a subset thereof, or an extension set thereof: an operating system 16051, which includes various system programs and is configured to implement various basic services and process a hardware-based task, and an application program module 16052, which includes various application programs and is configured to implement various application services.

The application program module 16052 includes but not limited to a set determining unit 1401 and a prediction mode determining unit 1402.

In this embodiment of the present disclosure, by invoking a program or an instruction stored in the memory 1605, the processor 1601 is configured to determine an allowable block partitioning depth set of a current block, and determine an optimal prediction mode of the current block according to the allowable block partitioning depth set.

In some embodiments of the present disclosure, the allowable block partitioning depth set may be a frame-level allowable block partitioning depth set, a block-level allowable block partitioning depth set, or a union set of a frame-level allowable block partitioning depth set and a block-level allowable block partitioning depth set. Certainly, the allowable block partitioning depth set may also include another block partitioning depth.

In some embodiments of the present disclosure, the frame-level allowable block partitioning depth set may include M block partitioning depths that are used most frequently within a current statistical period (where a time window length corresponding to the statistical period may be set according to a requirement) or until a current moment (“until a current moment” may be understood as from a set moment (where the set moment may be set according to a specific requirement, for example, the set moment may be a moment of coding a first video frame of a video to which a video frame belongs, where the current block belongs to the video frame, or the set moment may be a latest moment of coding a type or several specific types of video frames in a video to which a video frame belongs, where the current block belongs to the video frame, or the set moment may be a latest expiration moment of a timer or may be another moment) to the current moment) in a coded video frame that is of a same type as a video frame to which the current block belongs, where M is a positive integer. A value of M may be set according to a specific requirement, for example, the value of M may range from 2 to 5, or M may be equal to 2, 3, 4, 5, 6, 7, or another value.

In some embodiments of the present disclosure, the statistical period, for example, may be a length of one GOP, an interval between two adjacent intra-frames, an interval between two non-adjacent intra-frames, or an interval between any two intra-frames.

In some embodiments of the present disclosure, the block-level allowable block partitioning depth set may include K block partitioning depths or all block partitioning depths that are used by a prediction block of the current block, where K is a positive integer. A value of K may be set according to a specific requirement, for example, the value of K may range from 1 to 5, or K may be equal to 1, 2, 3, 4, 5, 6, 7, or another value.

P related blocks of the current block may include at least one of the following picture blocks: at least one adjacent block of the current block, a reference block of the current block, and at least one adjacent block of the reference block. For example, the P related blocks may include at least one adjacent block in four adjacent blocks of the current block (in this scenario, P is a positive integer); or the P related blocks may include the reference block of the current block (in this scenario, P is a positive integer equal to 1); or the P related blocks may include at least one adjacent block in four adjacent blocks of the reference block of the current block (in this scenario, P is a positive integer); or the P related blocks may include the reference block of the current block and at least one adjacent block in four adjacent blocks of the current block (in this scenario, P is a positive integer greater than 1); or the P related blocks may include the reference block of the current block and at least one adjacent block in four adjacent blocks of the reference block (in this scenario, P is a positive integer greater than 1); or the P related blocks may include at least one adjacent block in four adjacent blocks of the current block and at least one adjacent block in four adjacent blocks of the reference block of the current block (in this scenario, P is a positive integer greater than 1); or the P related blocks may include the at least one adjacent block of the current block, the reference block of the current block, and the at least one adjacent block of the reference block (in this scenario, P is a positive integer greater than 2).

In some embodiments of the present disclosure, if the current partitioning depth of the current block does not belong to the allowable block partitioning depth set, the optimal prediction mode of the current block at the current partitioning depth may be not calculated. The optimal prediction mode of the current block may be a prediction mode with a minimum rate-distortion cost in all optional prediction modes of the current block at the current partitioning depth (that is, to determine the optimal prediction mode of the current block at the current partitioning depth, further, rate-distortion costs corresponding to all the optional prediction modes of the current block at the current partitioning depth may be obtained by means of calculation, and the prediction mode with the minimum rate-distortion cost is used as the optimal prediction mode of the current block at the current partitioning depth); or the optimal prediction mode of the current block is a prediction mode with a minimum rate-distortion cost in multiple optional prediction modes of the current block at the current partitioning depth (that is, to determine the optimal prediction mode of the current block at the current partitioning depth, further, rate-distortion costs corresponding to the multiple optional prediction modes of the current block at the current partitioning depth may be obtained by means of calculation, and the prediction mode with the minimum rate-distortion cost is used as the optimal prediction mode of the current block at the current partitioning depth). It may be understood that the optimal prediction mode of the current block at the current partitioning depth may be not calculated if the current partitioning depth of the current block does not belong to the allowable block partitioning depth set, which helps to reduce, to some extent, calculation complexity in determining whether sub-block partitioning is performed on the current block at the current partitioning depth.

In some embodiments of the present disclosure, with respect to the determining an optimal prediction mode of the current block according to the allowable block partitioning depth set, the processor 1601 may be further configured to, if the current partitioning depth of the current block does not belong to the allowable block partitioning depth set, use a current prediction mode of the current block as the optimal prediction mode of the current block.

In some embodiments of the present disclosure, with respect to the determining the optimal prediction mode of the current block according to the allowable block partitioning depth set, the processor 1601 may be further configured to, if the current partitioning depth of the current block belongs to the allowable block partitioning depth set, obtain the optimal prediction mode of the current block by means of calculation, where the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

In some embodiments of the present disclosure, the optimal prediction mode of the current block may be any one of the following prediction modes: a skip mode, a direct mode, a block prediction mode, and a non-block prediction mode.

In some embodiments of the present disclosure, the block prediction mode is a prediction mode in which a width and a height of a prediction block are equal in size, and includes but is not limited to a 2N*2N prediction mode or an N*N prediction mode, where N is a positive integer, for example, N may be equal to the x^{th} power of 2, where x is a natural number.

In some embodiments of the present disclosure, the non-block prediction mode is a prediction mode in which a width and a height of a prediction block are not equal in size, and includes but is not limited to a 2N*1.5N prediction mode, a 2N*0.5N prediction mode, a 0.5N*2N prediction mode, an N*2N prediction mode, a 2N*N prediction mode, or a 1.5N*2N prediction mode, where N is a positive integer, for example, N may be equal to the x^{th} power of 2, where x is a natural number.

In some embodiments of the present disclosure, if the current partitioning depth of the current block belongs to the allowable block partitioning depth set, a rate-distortion cost of the current block may be a rate-distortion cost of the current block in the optimal prediction mode, and/or if the current partitioning depth of the current block is less than a minimum block partitioning depth in the allowable block partitioning depth set, the rate-distortion cost of the current block is a rate-distortion cost of the current block in the current prediction mode.

In some embodiments of the present disclosure, with respect to the calculating a rate-distortion cost obtained after sub-block partitioning is performed on the current block, the processor 1601 may be further configured to calculate, based on rate-distortion costs of all sub-blocks into which the current block is partitioned, the rate-distortion cost obtained after sub-block partitioning is performed on the current block.

In some embodiments of the present disclosure, with respect to the calculating, based on rate-distortion costs of all sub-blocks into which the current block is partitioned, the rate-distortion cost obtained after sub-block partitioning is performed on the current block, the processor 1601 may be further configured to use a weighted combination of rate-distortion costs of all sub-blocks into which the current block is partitioned (where weights of the rate-distortion costs of all the sub-blocks may be equal or not equal) as the rate-distortion cost obtained after sub-block partitioning is performed on the current block, or use the sum of rate-distortion costs of all sub-blocks into which the current block is partitioned as the rate-distortion cost obtained after sub-block partitioning is performed on the current block, or obtain, according to a maximum rate-distortion cost or a minimum rate-distortion cost of rate-distortion costs of all sub-blocks into which the current block is partitioned, the rate-distortion cost obtained after sub-block partitioning is performed on the current block (where, for example, a value obtained by multiplying the maximum rate-distortion cost or the minimum rate-distortion cost of the rate-distortion costs of all the sub-blocks by y1 is used as the rate-distortion cost obtained after sub-block partitioning is performed on the current block, where y1 may be an integer (for example, y1 is equal to 0.5, 1, 2, 3, 4, or another value)); or obtain, according to any rate-distortion cost of rate-distortion costs of all sub-blocks into which the current block is partitioned, the rate-distortion cost obtained after sub-block partitioning is performed on the current block (for example, a value obtained by multiplying any rate-distortion cost of the rate-distortion costs of all the sub-blocks by y2 is used as the rate-distortion cost obtained after sub-block partitioning is performed on the current block, where y2 may be an integer (for example, y2 is equal to 0.5, 1, 2, 3, 4, or another value)); or obtain, according to an average value of rate-distortion costs of all sub-blocks into which the current block is partitioned, the rate-distortion cost obtained after sub-block partitioning is performed on the current block (for example, a value obtained by multiplying the average value of the rate-distortion costs of all the sub-blocks by y3 may be used as the rate-distortion cost obtained after sub-block partitioning is performed on the current block, where y3 may be an integer (for example, y3 is equal to 0.5, 1, 2, 3, 4, or another value)).

Certainly, the rate-distortion cost obtained after sub-block partitioning is performed on the current block may also be calculated in another manner based on the rate-distortion costs of all the sub-blocks into which the current block is partitioned.

It may be understood that functions of all function modules of the video coder 1600 in this embodiment may be further implemented according to the method in the foregoing embodiment. For a specific implementation process of the functions, reference may be made to a related description in the foregoing method embodiment, and details are not described herein again.

It can be learned that in the solution of this embodiment, a video coder 1600 first determines an allowable block partitioning depth set of a current block in a video coding process, and then determines, according to the allowable block partitioning depth set, an optimal prediction mode of the current block. The encoding side can determine the optimal prediction mode of the current block according to the allowable block partitioning depth set of the current block, instead of determining the optimal prediction mode of the current block by calculating performance parameters such as rate-distortion costs of multiple blocks each time, thereby helping to reduce calculation complexity in determining the optimal prediction mode of the current block in the video coding process, and further helps to reduce calculation complexity in determining a block partitioning manner of the current block in the video coding process.

Further, the allowable block partitioning depth set of the current block may be a frame-level allowable block partitioning depth set, a block-level allowable block partitioning depth set, or a union set of a frame-level allowable block partitioning depth set and a block-level allowable block partitioning depth set. The block-level allowable block partitioning depth set includes K block partitioning depths used by a prediction block of the current block, where K is a positive integer. The frame-level allowable block partitioning depth set may include M block partitioning depths that are used most frequently within a current statistical period or until a current moment in a coded video frame that is of a same type as a video frame to which the current block belongs, where M is a positive integer. This exemplary manner of selecting the allowable block partitioning depth set helps to make the determined block partitioning manner of the current block tend to be more reasonable, thereby producing a better coding effect on the premise of balancing calculation complexity.

An embodiment of the present disclosure further provides a computer storage medium, where the computer storage medium may store a program, and the program, when being executed, includes all or a part of steps of the method for determining a block partitioning manner in video coding recorded in the foregoing method embodiment.

An embodiment of the present disclosure further provides a computer storage medium, where the computer storage medium may store a program, and the program, when being executed, includes all or a part of steps of the method for determining an optimal prediction mode of a current block in video coding recorded in the foregoing method embodiment.

It should be noted that, for brief description, the foregoing method embodiments are represented as a series of actions. However, persons skilled in the art should appreciate that the present disclosure is not limited to the described order of the actions, because according to the present disclosure, some steps may be performed in other orders or simultaneously. In addition, persons skilled in the art should also understand that the embodiments described in this specification all belong to exemplary embodiments, and the involved actions and modules are not necessarily mandatory to the present disclosure.

In the foregoing embodiments, the description of each embodiment has respective focuses. For a part that is not described in detail in an embodiment, reference may be made to related descriptions in other embodiments.

In the several embodiments provided in the present application, it should be understood that the disclosed apparatus may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, function units in the embodiments of the present disclosure may be integrated into one processing unit, or each of the units may exist alone physically, or two or more units are integrated into one unit. The integrated unit may be implemented in a form of hardware, or may be implemented in a form of a software function unit.

When the foregoing integrated unit is implemented in the form of a software function unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes: any medium that can store program code, such as a universal serial bus (USB) flash drive, a read-only memory (ROM), a random access memory (RAM), a removable hard disk, a magnetic disk, or an optical disc.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. A method for determining a block partitioning manner in video coding, comprising:
determining an allowable block partitioning depth set of a current block; and
determining, according to the allowable block partitioning depth set, whether sub-block partitioning is performed on the current block at a current partitioning depth.

2. The method according to claim 1, further comprising not calculating an optimal prediction mode of the current block at the current partitioning depth when the current partitioning depth of the current block does not belong to the allowable block partitioning depth set.

3. The method according to claim 1, wherein determining, according to the allowable block partitioning depth set, whether the sub-block partitioning is performed on the current block at the current partitioning depth comprises determining that sub-block partitioning is not performed on the current block when the current partitioning depth of the current block is greater than the maximum block partitioning depth in the allowable block partitioning depth set.

4. The method according to claim 1, wherein determining, according to the allowable block partitioning depth set, whether the sub-block partitioning is performed on the current block at the current partitioning depth comprises:
calculating a rate-distortion cost obtained after sub-block partitioning is performed on the current block when the current partitioning depth of the current block belongs to the allowable block partitioning depth set, or the current partitioning depth of the current block is less than the minimum block partitioning depth in the allowable block partitioning depth set;
determining that sub-block partitioning is not performed on the current block when the rate-distortion cost of the current block is less than or equal to the rate-distortion cost obtained after sub-block partitioning is performed on the current block; and
determining that sub-block partitioning is performed on the current block when the rate-distortion cost of the current block is greater than the rate-distortion cost obtained after sub-block partitioning is performed on the current block.

5. The method according to claim 4, wherein the rate-distortion cost of the current block is the rate-distortion cost of the current block in an optimal prediction mode when the current partitioning depth of the current block belongs to the allowable block partitioning depth set.

6. A method for determining an optimal prediction mode of a current block in video coding, comprising:
determining an allowable block partitioning depth set of a current block; and
determining an optimal prediction mode of the current block according to the allowable block partitioning depth set.

7. The method according to claim 6, further comprising not calculating the optimal prediction mode of the current block at the current partitioning depth when the current partitioning depth of the current block does not belong to the allowable block partitioning depth set.

8. The method according to claim 6, wherein determining the optimal prediction mode of the current block according to the allowable block partitioning depth set comprises using the current prediction mode of the current block as the optimal prediction mode of the current block when the current partitioning depth of the current block does not belong to the allowable block partitioning depth set.

9. The method according to claim 6, wherein determining the optimal prediction mode of the current block according to the allowable block partitioning depth set comprises obtaining the optimal prediction mode of the current block by means of calculation when the current partitioning depth of the current block belongs to the allowable block partitioning depth set, wherein the optimal prediction mode of the current block is a prediction mode with a minimum rate-distortion cost in all optional prediction modes of the current block at the current partitioning depth, or the optimal prediction mode of the current block is a prediction mode with a minimum rate-distortion cost in multiple optional prediction modes of the current block at the current partitioning depth.

10. The method according to claim 6, wherein the optimal prediction mode of the current block is any one of the following prediction modes: a skip mode, a direct mode, a block prediction mode, and a non-block prediction mode.

11. A video coder, comprising:
a computer processor configured to:
determine an allowable block partitioning depth set of a current block; and
determine, according to the allowable block partitioning depth set, whether sub-block partitioning is performed on the current block at a current partitioning depth.

12. The video coder according to claim 11, wherein the computer processor is further configured to not calculate an optimal prediction mode of the current block at the current partitioning depth when the current partitioning depth of the current block does not belong to the allowable block partitioning depth set.

13. The video coder according to claim 11, wherein the computer processor is further configured to determine that sub-block partitioning is not performed on the current block when the current partitioning depth of the current block is greater than the maximum block partitioning depth in the allowable block partitioning depth set.

14. The video coder according to claim 11, wherein the computer processor is further configured to:
calculate a rate-distortion cost obtained after sub-block partitioning is performed on the current block when the current partitioning depth of the current block belongs to the allowable block partitioning depth set, or the current partitioning depth of the current block is less than a minimum block partitioning depth in the allowable block partitioning depth set;
determine that sub-block partitioning is not performed on the current block when the rate-distortion cost of the current block is less than or equal to the rate-distortion cost obtained after sub-block partitioning is performed on the current block; and
determine that sub-block partitioning is performed on the current block when the rate-distortion cost of the current block is greater than the rate-distortion cost obtained after sub-block partitioning is performed on the current block.

15. A video coder, comprising:
a computer processor configured to:
determine an allowable block partitioning depth set of a current block; and
determine an optimal prediction mode of the current block according to the allowable block partitioning depth set.

16. The video coder according to claim 15, wherein the computer processor is further configured to not calculate an optimal prediction mode of the current block at the current partitioning depth when the current partitioning depth of the current block does not belong to the allowable block partitioning depth set.

17. The video coder according to claim 15, wherein the computer processor is further configured to use the current prediction mode of the current block as the optimal prediction mode of the current block when the current partitioning depth of the current block does not belong to the allowable block partitioning depth set.

18. The video coder according to claim 15, wherein the computer processor is further configured to obtain the optimal prediction mode of the current block by means of calculation when the current partitioning depth of the current block belongs to the allowable block partitioning depth set, wherein the optimal prediction mode of the current block is a prediction mode with the minimum rate-distortion cost in all optional prediction modes of the current block at the current partitioning depth, or the optimal prediction mode of the current block is a prediction mode with the minimum rate-distortion cost in multiple optional prediction modes of the current block at the current partitioning depth.

19. The video coder according to claim 15, wherein the optimal prediction mode of the current block is any one of the following prediction modes: a skip mode, a direct mode, a block prediction mode, and a non-block prediction mode.

20. A video coder, comprising:
a memory; and
a processor coupled to the memory, wherein the processor is configured to:
determine an allowable block partitioning depth set of a current block; and
determine, according to the allowable block partitioning depth set, whether sub-block partitioning is performed on the current block at a current partitioning depth.

21. The video coder according to claim 20, wherein the processor is further configured to not calculate an optimal prediction mode of the current block at the current partitioning depth when the current partitioning depth of the current block does not belong to the allowable block partitioning depth set.

22. The video coder according to claim 20, wherein the processor is further configured to determine that sub-block partitioning is not performed on the current block when the current partitioning depth of the current block is greater than the maximum block partitioning depth in the allowable block partitioning depth set.

23. The video coder according to claim 20, wherein the processor is further configured to:
calculate a rate-distortion cost obtained after sub-block partitioning is performed on the current block when the current partitioning depth of the current block belongs to the allowable block partitioning depth set, or the current partitioning depth of the current block is less than the minimum block partitioning depth in the allowable block partitioning depth set;
determine that sub-block partitioning is not performed on the current block when a rate-distortion cost of the current block is less than or equal to the rate-distortion cost obtained after sub-block partitioning is performed on the current block; and
determine that sub-block partitioning is performed on the current block when the rate-distortion cost of the current block is greater than the rate-distortion cost obtained after sub-block partitioning is performed on the current block.

24. The video coder according to claim 23, wherein the rate-distortion cost of the current block is the rate-distortion cost of the current block in an optimal prediction mode when the current partitioning depth of the current block belongs to the allowable block partitioning depth set.

25. A video coder, comprising:
a memory; and
a processor coupled to the memory, wherein the processor is configured to:
determine an allowable block partitioning depth set of a current block; and
determine an optimal prediction mode of the current block according to the allowable block partitioning depth set.

26. The video coder according to claim 25, wherein the processor is further configured to not calculate an optimal prediction mode of the current block at the current partitioning depth when the current partitioning depth of the current block does not belong to the allowable block partitioning depth set.

27. The video coder according to claim 25, wherein the processor is further configured to use a current prediction mode of the current block as the optimal prediction mode of the current block when the current partitioning depth of the current block does not belong to the allowable block partitioning depth set.

28. A computer storage medium, wherein the computer storage medium is configured to store a program, and when executed, the program performs a method comprising:
determining an allowable block partitioning depth set of a current block; and
determining, according to the allowable block partitioning depth set, whether the sub-block partitioning is performed on the current block at a current partitioning depth.
